(19) United States
(12) Patent Application Publication
(10) Pub. No.: US 2026/0127165 A1
(43) Pub. Date: May 7, 2026

(54) STRUCTURING-BASED KEY INFORMATION EXTRACTION IN MULTIMODAL MODELS FOR ENHANCING DOCUMENT UNDERSTANDING

(71) Applicant: Oracle International Corporation, Redwood Shores, CA (US)

(72) Inventors: Ashvini Kumar Sharma, Bengaluru (IN); Shirish Amit Bajpai, Bengaluru (IN); Amrit Bhaskar, Dumka (IN); Ankit Kumar Aggarwal, Mumbai (IN); Reetesh Mukul, Bangalore (IN)

(73) Assignee: Oracle International Corporation, Redwood Shores, CA (US)

(21) Appl. No.: 19/309,441

(22) Filed: Aug. 25, 2025

(30) Foreign Application Priority Data
Nov. 6, 2024 (IN) 202441085101

(51) Int. Cl. G06F 16/242; G06F 16/21

(52) U.S. Cl. CPC G06F 16/243; G06F 16/211

(57) ABSTRACT

A system and method for extracting structured key information from diverse document types using large multimodal models (LMMs) is disclosed. The invention employs a zero-shot analysis to identify candidate keys within an input document, then selects a document schema from a document schema database based on the identified keys. The LMM is prompted with the selected document schema to generate structured key-value pairs, with field constraints enforced by the document schema. Relationships among extracted keys are mapped to a graph representation, enabling robust handling of complex document layouts. The system supports nested structures, tabular data, and alias definitions for fields, and can update document schemas based on ground truth feedback. The resulting structured output is provided in a machine-readable format, enabling reliable and scalable document understanding across varied domains such as invoices, health cards, and driving licenses.

### CROSS REFERENCE TO RELATED APPLICATIONS

This application claims the benefit of priority to Indian Provisional Patent Application No. 2024/41085101, filed on Nov. 6, 2024, entitled “Structuring-Based Key Information Extraction In Multimodal Models For Enhancing Document Understanding.” The entire disclosure of the Indian provisional application is hereby incorporated by reference in its entirety for all purposes.

### FIELD

The present disclosure relates generally to automated document understanding systems and, more particularly, but not necessarily exclusively, to techniques for leveraging large multimodal models and structured schema-driven frameworks to extract, structure, and represent key information from diverse document types, including but not limited to invoices, health cards, and driving licenses.

### BACKGROUND

Automated document understanding has become increasingly important as organizations manage large volumes of digital documents in domains such as finance, healthcare, and government administration. Historically, information extraction from documents has relied on rule-based systems, template matching, and traditional optical character recognition (OCR) technologies to identify and extract key fields or data points from structured or semi-structured documents, such as invoices, identification cards, and forms.

While these conventional approaches have provided some automation benefits, they often require extensive customization for each document type, struggle to adapt to variations in layout and content, and may lack robustness in handling unstructured or complex formats. More recently, advances in machine learning and deep learning, including the use of multimodal models capable of processing both text and image data, have enabled improved performance in extracting information from diverse documents. However, these systems may still face challenges in generalizing across document types, maintaining accuracy, and ensuring reliable structured outputs in varying real-world scenarios.

### BRIEF SUMMARY

Various embodiments described herein relate to systems, methods, and computer program products for extracting structured key information from documents using large multimodal models (LMMs). In some examples, a system may include one or more computers, each of which can be configured by software, firmware, hardware, or any combination thereof, to perform operations as described. One or more computer programs, when executed by data processing apparatus, may cause the apparatus to carry out the described actions.

In various embodiments, techniques for extracting structured key information from documents may be provided using a computing system that can include at least one processor and a memory. In certain implementations, a computing system may be configured to receive an input document that can include image data, text data, or both. The system may use a large multimodal model to perform zero-shot analysis on the input document, generating a first set of candidate keys present in the document without any prior training specific to the document type. Based on the identified candidate keys, the system may select a document schema from a schema database. The selected schema may define multiple fields, with each field specifying a key, an expected data type, a required or default status, and one or more optional aliases.

The LMM may be prompted using the selected schema to generate a structured output comprising key-value pairs extracted from the input document, where the schema can be used to enforce field structure and data-type constraints. In some embodiments, the schema can further specify explicit data types and default values for each field, and absent fields in the input document may be assigned their respective default values in the structured output. The schema may also support nested structures and tabular data, such that the structured output can include hierarchically organized information or tabular representations, as appropriate for the document type.

A graph-based module may be included to map relationships among the extracted key-value pairs to a graph representation, where nodes may correspond to keys and edges may represent relationships between keys. In some examples, the graph-based module can identify at least one subgraph comprising a subset of the extracted keys and relationships, where the subgraph may be selected to maximize a utility function defined over nodes and edges, thereby optimizing the accuracy and relevance of the extracted information.

The system or method may further include, prior to outputting the structured output, evaluating the structured output against ground truth data and updating the schema in the schema database based on the evaluation if an accuracy metric falls below a predefined threshold. The LMM may be prompted with specialized prompt templates that can be tailored to the document type, with such prompt templates being dynamically generated or adapted based on the selected schema. The schema may include alias definitions for one or more fields, and the LMM may be configured to recognize and extract values corresponding to any of the aliases associated with a field.

Structured outputs may be provided in a machine-readable format, which can include, for example, JSON, XML, YAML, or other structured data formats suitable for downstream processing or integration. In some embodiments, a non-transitory computer-readable medium may store instructions that, when executed by at least one processor, cause the computing system to perform any of the methods described herein.

These and other embodiments may provide robust, schema-driven, and extensible frameworks for key information extraction from diverse document types using large multimodal models, while supporting adaptability, accuracy, and efficient integration into automated document processing workflows.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a chatbot system in accordance with various embodiments.

FIG. 2 is an exemplary architecture for a Large Language Model (LLM)-based digital assistant in accordance with various embodiments.

FIG. 3 is a simplified block diagram of a computing environment including a digital assistant that can execute an execution plan comprising actions and associated parameters for responding to an utterance from a user in accordance with various embodiments.

FIG. 4 is a simplified block diagram for training, testing, and using a machine learning model, in accordance with various embodiments.

FIG. 5 is a block diagram illustrating different challenges associated with document understanding, in accordance with various embodiments.

FIG. 6 is a block diagram illustrating a method to solve document understanding problems via LMM with structural representation, in accordance with various embodiments.

FIG. 7 is a diagram illustrating fields of a proposed generalized schema, in accordance with various embodiments.

FIG. 8 is an example of a driver's license document image, used to describe and explain key extraction, in accordance with various embodiments.

FIG. 9 is a block diagram illustrating the nested structure of an invoice, in accordance with various embodiments.

FIG. 10 is a diagram showing the correspondence between LMM output and structure mapping in accordance with various embodiments.

FIG. 11 illustrates a performance comparison of baseline LMMs vs schema tuned LMMs on driver's licenses, in accordance with various embodiments.

FIG. 12 illustrates a performance comparison of baseline LMMs vs schema tuned LMMs on health insurance cards, in accordance with various embodiments.

FIG. 13 illustrates, in accordance with various embodiments, a flowchart of a method for extracting structured key information from a document using a large multimodal model (LMM) and a schema-driven framework.

FIG. 14 is a block diagram illustrating one pattern for implementing a cloud infrastructure as a service system in accordance with various embodiments.

FIG. 15 is a block diagram illustrating another pattern for implementing a cloud infrastructure as a service system in accordance with various embodiments.

FIG. 16 is a block diagram illustrating another pattern for implementing a cloud infrastructure as a service system in accordance with various embodiments.

FIG. 17 is a block diagram illustrating another pattern for implementing a cloud infrastructure as a service system in accordance with various embodiments.

FIG. 18 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Artificial intelligence techniques have broad applicability. For example, a digital assistant can be or include an artificial intelligence driven interface that helps users accomplish a variety of tasks using natural language conversations. Conventionally, for each digital assistant, customers may assemble one or more skills that are focused on specific types of tasks, such as tracking inventory, submitting timecards, and creating expense reports. When an end user engages with the digital assistant, the digital assistant evaluates the end user input for the intent of the user and routes the conversation to and from the appropriate skill based on the user's perceived intent. However, there are some disadvantages of traditional intent-based skills including a limited understanding of natural language, inability to handle unknown inputs, limited ability to hold natural conversations off script, and challenges integrating external knowledge.

The advent of generative models such as large language models (LLMs) (e.g., GPT-4), has propelled the field of digital assistant design to unprecedented levels of sophistication and overcome these disadvantages and others of traditional intent-based skills. An LLM is a neural network that employs a transformer architecture, specifically crafted for processing and generating sequential data, such as text or words in conversations. LLMs undergo training with extensive textual data, gradually honing the ability to generate text that closely mimics human-written or spoken language. One of the key advantages of an LLM over a traditional Language Model (LM) is the ability to generalize to novel scenarios and domains much more effectively. Given the inherent flexibility of LLMs, it is desirable to utilize an LLM in a digital assistant as an agent framework (Agentic-AI) to respond to user questions. Agent frameworks reimagined with LLMs in an Agentic-AI environment allow seamless, out-of-the-box human-like conversation, easier asset unlocking, and high-quality routing and orchestration of requests.

The data curation pipeline for human-in-the-loop (HIL) data curation and training or fine-tuning LLMs is a multi-step process designed to ensure high-quality and relevant training data. The pipeline may use a combination of automated tools and human oversight to perform iterative cycles of data generation and refinement. For example, the pipeline typically begins with data acquisition, where raw data is sourced from diverse repositories, including open datasets, proprietary data, and user-generated content. Next, data annotation involves labeling the data with structured metadata or tags to provide context and meaning, often using human annotators. Data augmentation is then applied to enhance the dataset by introducing variations, such as paraphrasing, translations, or noise injection, to improve the model's robustness. Following this, quality assurance ensures the data is accurate, consistent, and free of bias or errors, typically through validation, sampling, and iterative manual reviews. Finally, the performance of the LLM is evaluated on this curated dataset using benchmarks, test cases, and metrics like accuracy, perplexity, or recall, allowing for iterative refinement and optimization of the model and in some instances the data curation pipeline.

However, certain data curation tasks may require complex workflows, such as generating diverse data from input seeds, ensuring alignment with specific metrics, or incorporating feedback from quality assurance (QA). Complex workflows in data curation for LLMs arise from the need to manage diverse and nuanced tasks that go beyond predefined automation processes. For instance, generating diverse data from input seeds requires iterative cycles of creativity and validation, where models may produce outputs that need refinement to ensure linguistic diversity, factual accuracy, and contextual relevance. Aligning datasets with specific metrics, such as fairness, bias mitigation, or domain-specific precision, demands careful calibration of data selection and augmentation processes, often requiring human oversight to account for subtleties that algorithms might miss. Incorporating feedback from QA adds another layer of complexity, as it involves reconciling subjective judgments from human evaluators with objective performance metrics, ensuring that the dataset aligns with desired outcomes while maintaining consistency and scalability. These challenges are compounded by the need for ongoing evaluation and adjustment to meet the dynamic requirements of the model's intended applications, making the pipeline inherently iterative and resource-intensive.

To address these challenges and others, a new pipeline and data curation techniques are described herein that incorporates mechanisms for dynamically integrating feedback and refining processes at each stage. More specifically, these mechanisms provide for (i) improved training data generation, (ii) efficient feedback loops, (iii) evaluator improvements, and (iv) preference data collection. The improved data generation leverages in-house LLM batch prediction to pre-annotate, which reduces human annotators' data sourcing efforts and facilitates the generation of diverse data. Additionally, improved data generation leverages tuned prompts (prompt engineering) from pre-annotation stage for use in direct production setup. An early pipeline feedback loop is utilized for pre-annotation quality from LLM-based auto-evaluation framework (Evaluator 1 & Evaluator 2 discussed herein) to significantly reduce long feedback loops for annotators from sourcing, annotation, to QA (Quality Assurance) into a small and faster iteration. The annotators can click to generate new data and get immediate quality feedback from the evaluators. This short and early feedback can reduce waste of work on the examples that potentially will fail the evaluation metrics. The early pipeline feedback loop can also reduce a significant amount of human QA's workloads. Instead of reviewing and correcting hundreds of random quality annotations, they now simply review medium to high quality annotations. This pipeline also improves evaluator accuracy based on QA's feedback. When a project starts, the evaluator might not be perfect and might not cover all edge cases. With clear feedback from QA, the pipeline can curate more edge cases and improve robustness of the evaluator. Lastly, the pipeline produces positive side products, which are three different preference data pairs in different stages (preference data between raw data augmentation output and auto-evaluator, preference data between auto-evaluator output and human annotator edited output, and preference data between human annotator edited output and QA validated output). Consequently, fine-tuning LLMs with curated data from the new pipeline and data curation techniques improve the model and have been found to boost LLM model performance, i.e., a pass-rate increase from 0.38 to 0.86 (micro). Additionally, data curation time decreases from an average of 13 mins to an average of 4.8 mins (×2.7 faster) per record.

In various embodiments, a computer-implemented method is described herein that can be used to generate and refine augmented data for training or evaluation purposes. The method can include accessing a curated set of input seeds that form the foundation of the data curation process. For example, these input seeds may include structured metadata, such as job titles or industry categories, that provide a starting point for generating downstream data. The method can further include applying a generative model to produce augmented input-output pairs based on the input seeds. The generative model may use prompts, templates, or other configurations to align generated data with task-specific requirements. The method can also include evaluating the augmented data using an automated evaluator, which may apply metrics such as variety, relevance, and quality. Data that meets the evaluation criteria may proceed to subsequent stages, while data that fails the criteria may be flagged for rework or refinement. In some embodiments, the evaluator may provide structured feedback that helps refine prompts, input seeds, or evaluation thresholds.

In some examples, the pipeline may include multiple evaluators designed to assess different aspects of the data at various stages. For instance, an initial evaluator may validate input seeds for diversity and task relevance, while a secondary evaluator may assess augmented input-output pairs for compliance with predefined quality metrics. Evaluators may operate in tandem with human annotators, who can refine or validate the outputs flagged during evaluation. In certain embodiments, evaluators may also be configured to analyze patterns in failed examples, identifying systemic issues that require adjustments to prompts, input seeds, or evaluation metrics. This multi-layered approach allows the pipeline to handle diverse scenarios, including tasks that require iterative feedback loops or complex workflows involving multiple sources of input and evaluation.

In some embodiments, preference data can play a role in fine-tuning the pipeline. A first generative model may generate augmented data and associate it with evaluation metrics to form preference data pairs. These pairs may include relationships between raw outputs, human-edited annotations, and QA-validated results. The preference data may then be used to optimize the generative model, refining its parameters to align future outputs more closely with user preferences or quality standards. Similarly, preference data may be applied to evaluators, enabling them to adapt their scoring criteria based on historical data or user feedback. For example, an evaluator may use preference data to identify edge cases or refine thresholds for specific metrics, enhancing its ability to assess nuanced aspects of data quality. This iterative refinement process ensures that both the generative model and evaluators improve over time, leading to more efficient and accurate data curation workflows.

In some examples, the pipeline may also support dynamic feedback mechanisms that improve the efficiency of the overall process. For instance, a second generative model may generate feedback for annotators or evaluators, providing suggestions for refining annotations or adjusting evaluation criteria. This feedback may be integrated into the pipeline through dashboards, reports, or automated workflows, allowing project managers and annotators to adapt their approaches dynamically. Additionally, the pipeline may include mechanisms for generating unit test cases from failed examples, enabling continuous improvement of evaluators and other automated tools. By combining preference data, iterative feedback loops, and multi-layered evaluation frameworks, the pipeline can handle complex data curation tasks with greater flexibility and precision.

As used herein, when an action is “based on” something, this means the action is based at least in part on at least a part of the something. As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Digital Assistant and Knowledge Dialog

A bot (also referred to as an agent, chatbot, chatterbot, or talkbot), implemented as part of or as a digital assistant, is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile, web, and cloud application extensions or plugins that extend native or hybrid/responsive mobile, web, or cloud applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) or API call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined or pre-processed for input to a bot that is identified to be associated with the invocation name and/or communication.

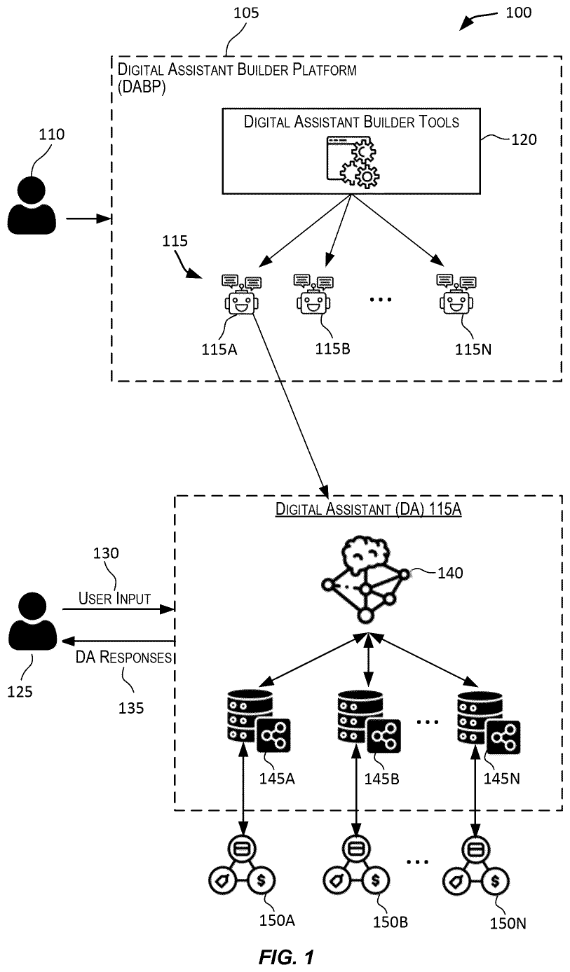

FIG. 1 is a simplified block diagram of an environment 100 incorporating a digital assistant system (also described herein as simply a digital assistant or in more specific terms with reference to implementation of agents as an agent assistant) according to certain embodiments. Environment 100 includes a digital assistant builder platform (DABP) 105 that enables users 110 to create and deploy digital assistant systems 115. For purposes of this disclosure, a digital assistant is an entity that helps users of the digital assistant accomplish various tasks through natural language conversations. The DABP and digital assistant can be implemented using software only (e.g., the digital assistant is a digital entity implemented using programs, code, or instructions executable by one or more processors), using hardware, or using a combination of hardware and software. In some instances, the environment 100 is part of an Infrastructure as a Service (IaaS) cloud service (as described below in detail) and the DABP and digital assistant can be implemented as part of the IaaS by leveraging the scalable computing resources and storage capabilities provided by the IaaS provider to process and manage large volumes of data and complex computations. This setup allows the DABP and digital assistant to deliver real-time, responsive interactions while ensuring high availability, security, and performance scalability to meet varying demand levels. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistant systems (or DAs). For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

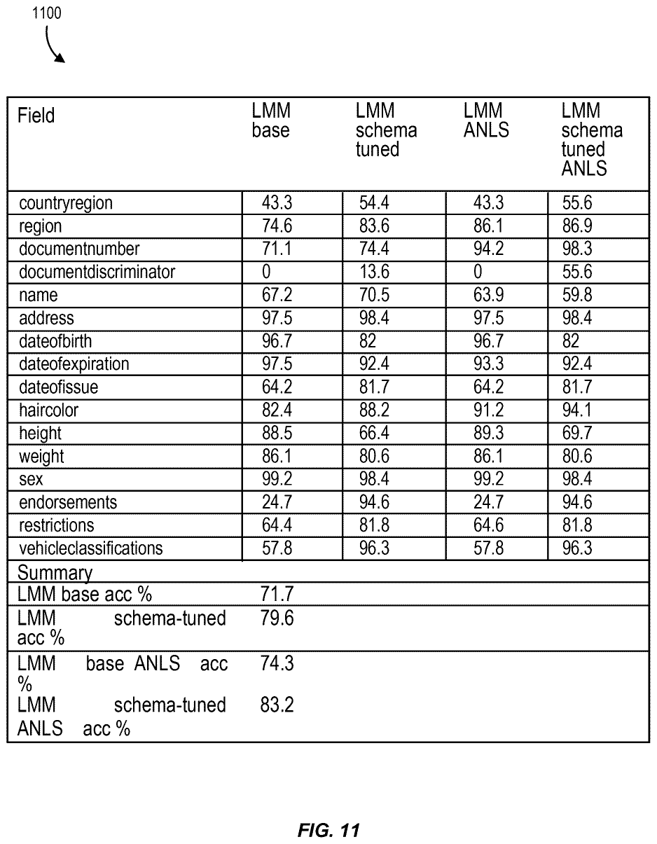

To create one or more digital assistant systems 115, the DABP 105 is equipped with a suite of tools 120, enabling the acquisition of machine learning models, agent creation, asset identification, and deployment of digital assistant systems within a service architecture for users via a computing platform such as a cloud computing platform described in detail with respect to FIGS. 11-15. In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

In some instances, the tools 120 can be utilized to access pre-trained and/or fine-tuned generative models such as LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

The tools 120 further include a prompt-based agent composition unit for creating agents and their associated actions that an end-user can end up invoking. An agent is a container of agent actions and can be part of one or more digital assistants. Each digital assistant may contain one or more agents through a digital assistant relation, which is the intersection entity that links an agent to a digital assistant. The agent and digital assistant are implemented as bot subtypes and may be persisted into an existing BOTS table. This has advantages in terms of reuse of design-time code (e.g., Java code) and UI artefacts.

An agent action is of a specific action type (e.g., knowledge, service or API, LLM, etc.) and contains a description and schema (e.g., JSON schema) which defines the action parameters. The action description and parameters schema are indexed by semantic index and sent to the planner to select the appropriate action(s) to execute. The action parameters are key-value pairs that are input for the action execution. They are derived from the properties in the schema but may also include additional UI/dialog properties that are used for slot filling dialogs. The actions can be part of one or more classes. For example, some actions may be part of an application event subscription class, which defines an agent action that should be executed when an application event is received. The application event can be received in the form of un update application context command message. An application event property mapping class (part of the application event subscription class) specifically maps the application event payload properties to corresponding agent action parameters. An action can optionally be part of an action group. An action group may be used when importing a plugin manifest, or when importing an external API spec such as an Open API spec. An action group is particularly useful when re-importing a plugin or open API spec, so new actions can be added, existing actions can be updated, or actions that are no longer present in the new manifest or Open API spec can be removed. At runtime, an action group may only be used to limit the application context groups that are sent to the LLM as conversation context by looking up the action group name which corresponds to a context group context.

The agents (e.g., 401k Change Contribution Agent) may be primarily defined as a compilation of agent artifacts using natural language within the prompt-based agent composition unit. Users 110 can create functional agents quickly by providing agent artifact information, parameters, and configurations and by pointing to assets. The assets can be or include resources, such as APIs for interfacing with applications, files and/or documents for retrieving knowledge, data stores for interacting with data, and the like, available to the agents for the execution of actions. The assets are imported, and then the users 110 can use natural language again to provide additional API customizations for dialog and routing/reasoning. Most of what an agent does may involve executing actions. An action can be an explicit action that's authored using natural language (similar to creating agent artifacts—e.g., ‘What is the impact of XYZ on my 401k Contribution limit?’ action in the below ‘401k Contribution Agent’ figure) or an implicit action that is created when an asset is imported (automatically imported upon pointing to a given asset based on metadata and/or specifications associated with the asset—e.g., actions created for Change Contribution and Get Contribution API in the below ‘401k Contribution Agent’ figure). The design time user can easily create explicit actions. For example, the user can choose the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets) the agent references (thus was not implicitly added as an action).

TABLE 1

| | Action | |
|---|---|---|
| | Type | Description |
| 1 | Prompt | The action is implemented using a prompt to an LLM. |
| 2 | Rich | The action is implemented using rich text. The most |
| | Text | common use case is FAQs. |
| 3 | Flow | The action is implemented using Visual Flow Designer |
| | | flow. May be used for complex cases where the developer |
| | | is not able to use the out-of-the-box dialogue and |
| | | dialog customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

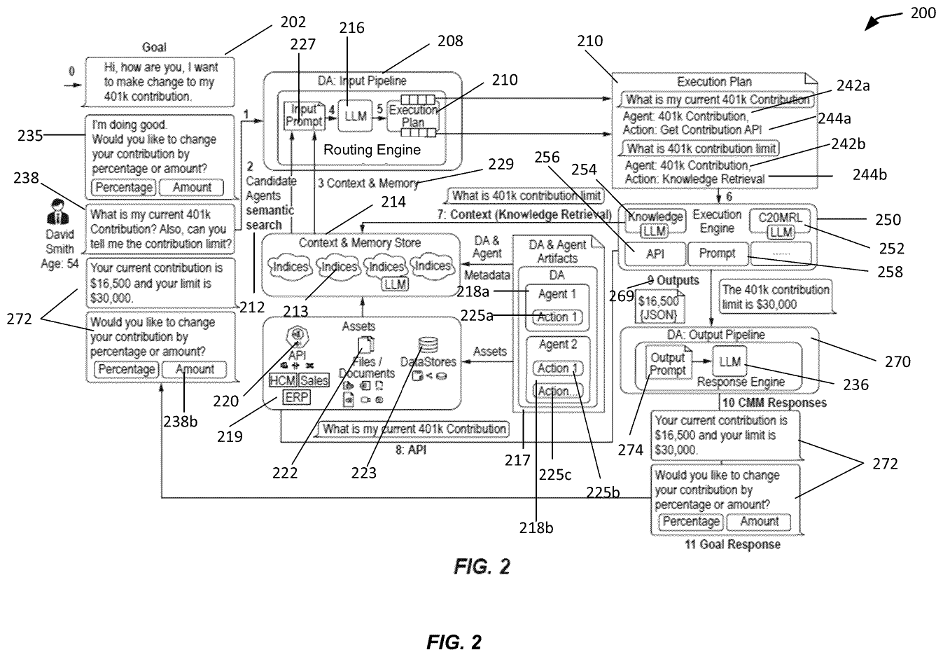

Once deployed in a production environment, such as the architecture described with respect to FIG. 2, a digital assistant, such as digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A via a user interface element such as a chat window. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140. Conversations shown in the chat window can be organized by thread. For example, in some applications, a conversation related to one page of an application should not be mixed with a conversation related to another page of the application. The application and/or the plugins for the application define the thread boundaries (e.g., a set of (nested) plugins can run within their own thread). Effectively, the chat window will only show the history of messages that belong to the same thread. Setting and changing the thread can be performed via the application and/or the plugins using an update application context command message. Additionally or alternatively, the thread can be changed via an execution plan orchestrator when a user query is matched to a plugin semantic action and the plugin runs in a thread different than the current thread. In this case, the planner changes threads, so that any messages sent in response to the action being executed are shown in the correct new thread. Per agent dialog thread, the following information can be maintained by the digital assistant: the application context, the LLM conversation history, the conversation history with the user, and the agent execution context which holds information about the (stacked) execution plan(s) related to this thread.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user input 130 is in speech form, the speech input is converted to text form user input 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more generative models such as LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A-knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems, subsystems, and generative models as described in greater detail with respect to FIG. 2) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 2 is an example of an architecture for a computing environment 200 (an Agentic-AI environment) for a digital assistant implemented with generative artificial intelligence in accordance with various embodiments. As illustrated in FIG. 2, an infrastructure and various services and features can be used to enable a user to interact with a digital assistant (e.g., digital assistant 115A described with respect to FIG. 1) based at least in part on a series of prompts such as a conversation and/or a series of actions such as interactions with a user interface. The following is a detailed walkthrough of a conversation flow and the role and responsibility of the components, services, models, and the like of the computing environment 200 within a conversation flow. In this walkthrough, it is assumed that a user “David” is interested in making a change to his 401k contribution, and in an utterance 202, David provides the following input: Hi, how are you, I want to make a change to my 401k contribution. The utterance 202 can be communicated to the digital assistant (e.g., via a digital assistant user interface such as a text dialogue box or microphone). At this stage upon receipt of the utterance 202, a sessionizer creates a new session or retrieves the current session context and a user message publisher updates session transcript and LLM message history with the new user message (e.g., utterance 202).

In instances where the user provides the utterance 202 and/or performs an action while using an application supported by a digital assistant, the application issues update application context commands as the user interacts with the application (e.g., provides an utterance via text or audio, triggers a user interface element, navigates between pages of the application, and the like). Whenever an update application context command message is received by the digital assistant from the application, the application context processor (part of the context manager) is implemented. The application context processor performs the following tasks: (i) manages dialog threads based on the application context message, e.g., if the threadId specified with the message doesn't exist yet, a new dialog thread is created and made current, and if the threadId already exists, the corresponding dialog thread is made current, (ii) creates or updates the application context object for the current dialog thread, (iii) if a service call ID such as a REST request ID is included, the application context may be enriched (as described in greater detail herein). As should be understood, the application context only contains information that reflects the state of the application user interface and plugins (if available), it does not contain other state information (e.g., user or page state information/context).

Is some instances, when an update application context command message is received, an application event processor checks on whether the update application context command message includes an event definition. The event is uniquely identified by the following properties in the message payload: (i) context: the context path and/or the plugin path (For a top-level workspace plugin the context is set to the plugin name, for nested plugins the plugin path is included where plugins are separated with a slash, for example Patient/Vitalschart), (ii) eventType: the type of event can be one of the built in events or a custom event, and (iii) semantic object: the semantic object to which the event applies. An event can be mapped to one or more actions, and the message payload properties can be mapped to action parameters. This mapping takes place through an application event subscription. Each property in the message payload can be mapped to an agent action parameter using an application event property mapping.

In some instances, the utterance 202 and/or action performed by the user is provided directly as input to a routing engine 208 (also referred to as a planner). In other instances where the application event processor is implemented, the utterance 202 and/or action performed by the user is provided as input to the routing engine 208 when the application event processor determines an event such as receipt of utterance 202 is mapped to an agent or action associated with the digital assistant. The routing engine 208 is used by the digital assistant to create an execution plan 210 with specified parameters either from the utterance 202, the action performed by the user, the context, or any combination thereof. The execution plan 210 identifies one or more agents and/or one or more actions for the one or more agents to execute in response to the utterance 202 and/or action performed by the user.

A two-step approach can be taken via the routing engine 208 to generate the execution plan 210. First, a search 212 can be performed to identify a list of candidate agents and/or actions. The search 212 comprises running a query on indices 213 (e.g., semantic indices) of a context and memory store 214 based on the utterance 202 and/or action performed by the user. In some instances, the search 212 is a semantic search performed using words from the utterance 202 and/or representative of the action performed by the user. The semantic search uses NLP and optionally machine learning techniques to understand the meaning of the utterance 202 and/or action performed by the user and retrieve relevant information from the context and memory store 214. In contrast to traditional keyword-based searches, which rely on exact matches between the words in the query and the data in the context and memory store 214, a semantic search takes into account the relationships between words, the context of the query and/or action, synonyms, and other linguistic nuances. This allows the digital assistant to provide more accurate and contextually relevant results, making it more effective in understanding the user's intent in the utterance 202 and/or action performed by the user.

In order to run the query, the routing engine 208 calls the context and memory store 214 (e.g., a semantic index of the context and memory store 214) to get the list of candidate agents and/or actions. The following information is passed in the call: (i) the ID of the digital assistant (the ID scopes the set of agent and/or actions the semantic index will search for and thus the agents and/or actions must be part of the digital assistant), and (ii) the last X number of user messages and/or actions (e.g., X can be set to the last 5 turns), which can be configurable through the digital assistant settings. Upon receiving the list of candidate agents and/or actions, the routing engine 208 can identify an associated schema with the actions and perform slot-filling to determine any missing input arguments for the schema.

The context and memory store 214 is implemented using a data framework for connecting external data to one or more generative models such as LLMs 216 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 217 associated with the digital assistant and its agents 218 (e.g., 218a and 218b). The artifacts 217 for the digital assistant include information on the general capabilities of the digital assistant and specific information concerning the capabilities of each of the agents 218 (e.g., actions) available to the digital assistant (e.g., agent artifacts). Additionally or alternatively, the artifacts 217 can encompass parameters or information associated with the artifacts 217 and that can be used to define the agents 218 in which the parameters or information associated with the artifacts 217 can include a name, a description, one or more actions, one or more assets, one or more customizations, etc. In some instances, the data further includes metadata extracted from assets 219 associated with the digital assistant and its agents 218 (e.g., 218a and 218b). The assets 219 may be resources, such as APIs 220, files and/or documents 222, data stores 223, and the like, available to the agents 218 for the execution of actions (e.g., actions 225a, 225b, and 225c). The data is indexed in the context and memory store 214 as indices 213, which are data structures that provide a fast and efficient way to look up and retrieve specific data records within the data. Consequently, the context and memory store 214 provides a searchable comprehensive record of the capabilities of all agents and associated assets that are available to the digital assistant for responding to the request and/or action.

The response of context and memory store 214 is converted into a list of agent and/or action instances that are not just available to the digital assistant for responding to the request but also potentially capable of facilitating the generation of a response to the utterance 202 and/or action performed by the user. The list of candidate agents and/or actions includes the metadata (e.g., metadata extracted from artifacts 217 and assets 219) from the context and memory store 214 that is associated with each of the candidate agents and/or actions. The list can be limited to a predetermined number of candidate agents and/or actions (e.g., top 10) that satisfy the query or can include all agents and/or actions that satisfy the query. The list of candidate agents and/or actions with associated metadata is appended to the utterance 202 and/or action performed by the user to construct an input prompt 227 for the LLM 216. The search 212 is important to the digital assistant because it filters out agents and/or actions that are unlikely to be capable of facilitating the generation of a response to the utterance 202 and/or action performed by the user. This filter ensures that the number of tokens (e.g., word tokens) generated from the input prompt 227 remains under a maximum token limit or context limit set for the LLM 216. Token limits represent the maximum amount of text that can be inputted into an LLM. This limit is of a technical nature and arises due to computational constraints, such as memory and processing resources, and thus makes certain that the LLMs can take the input prompt as input.

In some instances, one or more knowledge actions are additionally appended to the list of candidate agents and the utterance 202. The knowledge actions allow for additional knowledge to be acquired that is pertinent to the utterance 202 and/or action performed by the user (this knowledge is typically outside the scope of the knowledge used to train an LLM of the digital assistant). The are two types of knowledge action sources: (i) structure: the knowledge source defines a list of pre-defined questions that the user might ask and exposes them as some APIs (e.g., Multum), and (ii) unstructured: with the knowledge source, the user has unlimited ways to ask questions and the knowledge source exposes a generic query interface (e.g., medical documents (SOAP notes, discharge summary, etc.)).

In some instances, conversation context 229 concerning the utterance 202 are additionally appended to the list of candidate agents and the utterance 202. The conversation context 229 can be retrievable from one or more sources including the context and memory store 214, and includes user session information, dialog state, conversation or contextual history, application context, page context, user information, or any combination thereof. For example, the conversation context 229 can include: the current date and time, needed to resolve temporal references in user query like “yesterday”, or “next Thursday”, additional context, which contains information such as user profile properties and application context groups with semantic object properties, and the chat history with the digital assistant (and/or other digital assistant or system internal or external to the computing environment 200.

The second step of the two-step approach is for the LLM 216 to generate an execution plan 210 based on the input prompt 227. The LLM 216 can be invoked by creating an LLM chat message with role system passing in the input prompt 227, converting the candidate agents and/or actions into LLM function definitions, retrieving a proper LLM client based on the LLM configuration options, optionally transforming the input prompt 227, LLM chat message, etc. into a proper format for the LLM client, and sending the LLM chat message to the LLM client for invoking the LLM 216. The LLM client then sends back an LLM success response in CLMI format or a provider specific response is converted back to the LLM success response in CLMI format using an adapter such as OpenAIAdapter (or send back or is converted to an LLM error response in case an unexpected error occurred). An LLM call instance is created and added to the conversation history which captures all the request and response details including the execution time.

The LLM 216 has a deep generative model architecture (e.g., a reversible or autoregressive architecture with) for generating the execution plan 210. In some instances, the LLM 216 has over 100 billion parameters and generates the execution plan 210 using autoregressive language modeling within a transformer architecture, allowing the LLM 216 to capture complex patterns and dependencies in the input prompt 227. The LLM's 216 ability to generate the execution plan 210 is a result of its training on diverse and extensive textual data, enabling the LLM to understand human language across a wide range of contexts. During training, the LLM 216 learns to predict the next word in a sequence given the context of the preceding words. This process involves adjusting the model's parameters (weights and biases) based on the errors between its predictions and the actual next words in the training data. When the LLM 216 receives an input such as the input prompt 227, the LLM 216 tokenizes the text into smaller units such as words or sub-words. Each token is then represented as a vector in a high-dimensional space. The LLM 216 processes the input sequence token by token, maintaining an internal representation of context. The LLM's 216 attention mechanism allows it to weigh the importance of different tokens in the context of generating the next word. For each token in the vocabulary, the LLM 216 calculates a probability distribution based on its learned parameters. This probability distribution represents the likelihood of each token being the next word given the context. For example, to generate the execution plan 210, the LLM 216 samples a token from the calculated probability distribution. The sampled token becomes the next word in the generated sequence. This process is repeated iteratively, with each newly generated token influencing the context for generating the subsequent token. The LLM 216 can continue generating tokens until a predefined length or stopping condition is reached.

In some instances, as illustrated in FIG. 2, the LLM 216 may not be able to generate a complete execution plan 210 because it is missing information such as if more information is required to determine an appropriate agent for the response, execute one or more actions, or the like. In this particular instance, the LLM 216 has determine that in order to change the 401k contribution as request by the user, it is necessary to understand whether the user would like to change the contribution by a percentage or certain currency amount. In order to obtain this information, the LLM 216 (or another LLM such as LLM 236) generates end-user response 235 (I'm doing good. Would you like to change your contribution by percentage or amount? [Percentage] [Amount]) to the input prompt 227 that can obtain the missing information such that the LLM 216 is able to generate a complete execution plan 210. In some instances, the response may be rendered within a dialogue box of a UI having one or more UI elements allowing for an easier response by the user. In other instances, the response may be rendered within a dialogue box of a UI allowing for the user to reply using the dialogue box (or alternative means such as a microphone). In this particular instance, the user responds with an additional query 238 (What is my current 401k Contribution? Also, can you tell me the contribution limit?) to gather additional information such that the user can reply to the response 235. The subsequent response-additional query 238—is input into the routing engine 208 and the same processes described above with respect to utterance 202 are executed but this time with the context of the prior utterances/replies (e.g., utterance 202 and response 235) from the user's conversation with the digital assistant. This time, as illustrated in FIG. 2, the LLM 216 is able to generate a complete execution plan 210 because it has all the information it needs.

In some instances, the utterance 202 by the user may be determined by the LLM 216 to be non-sequitur (i.e., an utterance that does not logically follow from the previous utterance in a dialogue or conversation). In such an instance, an execution plan orchestrator can be used to handle the switch among different dialog paths. The execution plan orchestrator is configured to track all the ongoing conversation paths, create a new entry if a new dialog path is created and pause the current ongoing conversation if any, remove the entry if the conversation completes based on the metadata of the new action or user preference, it might generate a prompt message when starting a non-sequitur or resuming the previous one, manage the dialog for the prompt message and either proceed or restore the current conversation, confirm or cancel when the user responds to the prompt for the non-sequitur. and manages a cancel or exit from a dialog.

The execution plan 210 includes an ordered list of agents and/or actions that can be used and/or executed to sufficiently respond to the request such as the additional query 238. For example, and as illustrated in FIG. 2, the execution plan 210 can be an ordered list that includes a first agent 242a capable of executing a first action 244a via an associated asset and a second agent 242b capable of executing a second action 244b via an associated asset. The agents, and by extension the actions, may be ordered to cause the first action 244a to be executed by the first agent 242a prior to causing the second action 244b to be executed by the second agent 242b. In some instances, the execution plan 210 may be ordered based on dependencies indicated by the agents and/or actions included in the execution plan 210. For example, if executing the second agent 242b is dependent on, or otherwise requires, an output generated by the first agent 242a executing the first action 244a, then the execution plan 210 may order the first agent 242a and the second agent 242b to comply with the dependency. As should be understood, other examples of dependencies are possible.

The execution plan 210 is then transmitted to an execution engine 250 for implementation. The execution engine 250 includes a number of engines, including a natural language-to-programming language translator 252, a knowledge engine 254, an API engine 256, a prompt engine 258, and the like. for executing the actions of agents and implementing the execution plan 210. For example, the natural language-to-programming language translator 252, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 219 such as data stores 223 to execute actions and/or obtain data or information. The knowledge engine 254 may be used by an agent to obtain data or information from the context and memory store 214 or an asset 219 such as files/documents 222. The API engine 256 may be used by an agent to call an API 220 and interface with an application such as retirement fund account management application to execute actions and/or obtain data or information. The prompt engine 258 may be used by an agent to construct a prompt for input into an LLM such as an LLM in the context and memory store 214 or an asset 219 to execute actions and/or obtain data or information.

The execution engine 250 implements the execution plan 210 by running each agent and executing each action in order based on the ordered list of agents and/or actions using the appropriate engine(s). To facilitate this implementation, the execution engine 250 is communicatively connected (e.g., via a public and/or provue network) with the agents (e.g., 242a, 242b, etc.), the context and memory store 214, and the assets 219. For example, as illustrated in FIG. 2, when the execution engine 250 implements the execution plan 210, it will first execute the agent 242a and action 244a using API engine 256 to call the API 220 and interface with a retirement fund account management application to retrieve the user's current 401k contribution. Subsequently, the execution engine 250 can execute the agent 242b and action 244b using knowledge engine 254 to retrieve knowledge on 401k contribution limits. In some instances, the knowledge is retrieved by knowledge engine 254 from the assets 219 (e.g., files/documents 222). In other instances (as in this particular instance), the knowledge is retrieved by knowledge engine 254 from the context and memory store 214. Knowledge retrieval and action execution using the context and memory store 214 may be implemented using various techniques including internal task mapping and/or machine learning models such as additional LLM models. For example, the query and associated agent for “What is 401k contribution limit” may be mapped to a ‘semantic search’ knowledge task type for searching the indices 213 within the context and memory store 214 for a response to a given query. By way of another example, a request such as “Can you summarize the key points relating to 401k contribution” can be or include a ‘summary’ knowledge task type that may be mapped to a different index within the context and memory store 214 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 214 are optimized to the various task or action types.

The result of implementing the execution plan 210 is output data 269 (e.g., results of actions, data, information, etc.), which is transmitted to an output pipeline 270 for generating end-user responses 272. For example, the output data 269 from the assets 219 (knowledge, API, dialog history, etc.) and relevant information from the context and memory store 214 can be transmitted to the output pipeline 270. The output data 269 is appended to the utterance 202 to construct an output prompt 274 for input to the LLM 236. In some instances, context 229 concerning the utterance 202 are additionally appended to the output data 269 and the utterance 202. The context 229 is retrievable from the context and memory store 214 and includes user session information, dialog state, conversation or contextual history, user information, or any combination thereof. The LLM 236 generates responses 272 based on the output prompt 274. In some instances, the LLM 236 is the same or similar model as LLM 216. In other instances, the LLM 236 different from LLM 216 (e.g., trained on a different set of data, a different architecture, trained for a one or more different tasks, etc.). In either instance, the LLM 236 has a deep generative model architecture (e.g., a reversible or autoregressive architecture with) for generating the responses 272 using similar training and generative processes described above with respect to LLM 216. In some instances, the LLM 236 has over 100 billion parameters and generates the responses 272 using autoregressive language modeling within a transformer architecture, allowing the LLM 236 to capture complex patterns and dependencies in the output prompt 274.

In some instances, the end-user responses 272 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)·location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 270 transmits the responses 272 to the end user such as via a user device or interface. In some instances, the responses 272 are rendered within a dialogue box of a GUI allowing for the user to view and reply using the dialogue box (or alternative means such as a microphone). In other instances, the responses 272 are rendered within a dialogue box of a GUI having one or more GUI elements allowing for an easier response by the user. In this particular instance, a first response 272 (What is my current 401k Contribution? Also, can you tell me the contribution limit?) to the additional query 238 is rendered within the dialogue box of a GUI. Additionally, in order to follow-up on obtaining information still required for the initial utterance 202, the LLM 236 generates another response 272 prompting the user for the missing information (Would you like to change your contribution by percentage or amount? [Percentage] [Amount]).

While the embodiment of computing environment 200 in FIG. 2 illustrates the digital assistant interacting in a particular conversation flow, this is not intended to be limiting and is merely provided to facilitate a better understanding of the role and responsibility of the components, services, models, and the like of the computing environment 200 within the conversation flow.

### Block Diagrams for Computing Environments Including a Routing Agent for Digital Assistant

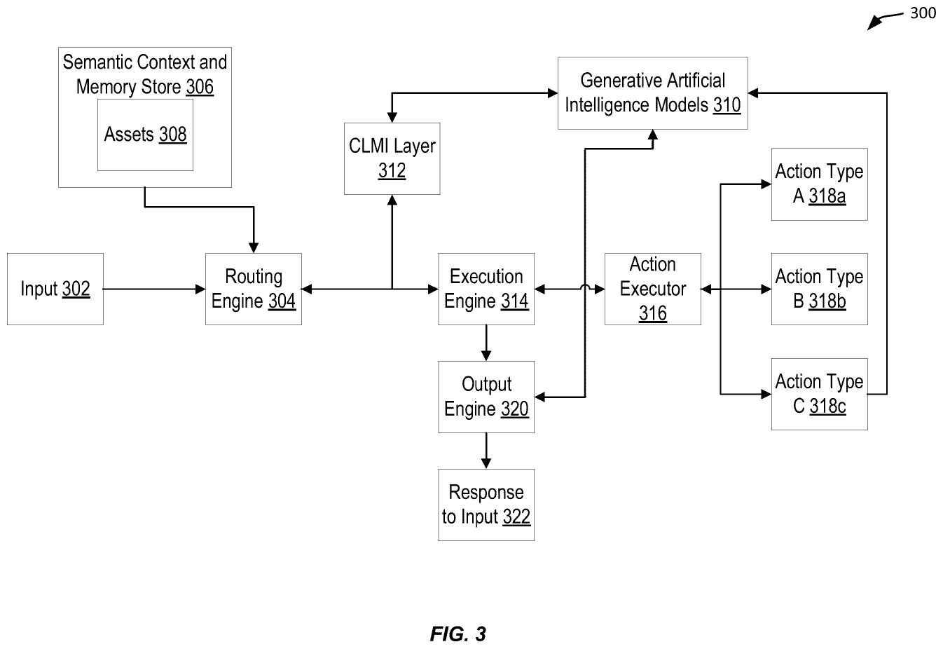

FIG. 3 is a simplified block diagram of a computing environment (e.g., computing environment 200 described with respect to FIG. 2) including a digital assistant 300 that can execute an execution plan comprising actions and associated parameters for responding to an utterance from a user in accordance with various embodiments. In some embodiments, the utterance may be provided from the user to the digital assistant 300 via input 302. The input 302 may be or include natural language utterances that can include text input, voice input, image input, or any other suitable input for the digital assistant 300. For example, the input 302 may include text input provided by the user via a keyboard or touchscreen of a computing device used by the user. In other examples, the input 302 may include spoken words provided by the user via a microphone of the computing device. In other examples, the input 302 may include image data, video data, or other media provided by the user via the computing device. Additionally or alternatively, the input 302 may include indications of actions to be performed by the digital assistant 300 on behalf of the user. For example, the input 302 may include an indication that the user wants to order a pizza, that the user wants to update a retirement account contribution, or other suitable indications.

The input 302 may be provided to a routing engine 304, which may also be referred to as a routing agent. The routing engine 304 may generate an execution plan based on the input 302 and based on context provided to the routing engine 304. The routing engine 304 may receive the input 302 and may make a call to a semantic context and memory store 306 to retrieve the context. In some embodiments, the semantic context and memory store 306 includes one or more assets 308, which may be similar or identical to the assets 219. The routing engine 304 may provide at least a portion of the input 302 to the semantic context and memory store 306, which can perform a semantic search on the assets 308 and/or other knowledge included in the semantic context and memory store 306. The semantic search may generate a list of candidate actions, or candidate tools, from among all actions that can be performed via one or more of the assets 308, that may be used to address the input 302 or any subset thereof. In some embodiments, the candidate actions may be generated only based on contextual information. For example, the input 302 may be compared with metadata of the actions to generate the candidate actions. Table 2 lists particular examples of context information and candidate actions that can be received by the routing engine 304 and an execution plan that can be generated by the routing engine 304.

TABLE 2

| Routing Component | Example | | | |
|---|---|---|---|---|
| Context Information | • | User Profile: | | |
| | | - | | Employee Id: 765943 |
| | | - | | Name: Natasha Gill |
| | | - | | Age: 40 |
| | | - | | Country: USA |
| | • | Conversation History: | | |
| | | | | [User]: Hi, I'd like to submit an expense. |
| | | | | [Assistant]: To create the expense, I need to know the amount, date and |
| | | | | the merchant for this expense. Can you provide the amount first? |
| | | | | [User]: Burger King was the merchant. |
| | | | | [Assistant]: Please provide me with the amount for this expense. |
| | | | | [User]: You're right, 8L it was. |
| | | | | [Assistant]: Sorry, the provided input is invalid. To create the expense, I |
| | | | | need the amount and the date for this expense. Can you provide the |
| | | | | amount first? |
| Candidate Actions or | • | “Create_Expense”: | | |
| Tools | | | - | Agent: Expense agent |
| | | | - | Description: Create expense |
| | | | - | args JSON schema: [{“name”: “employee_id”, “description”: |
| | | | | “Employee ID”, “type”: “Integer”, “required”: true}, {“name”: |
| | | | | “amount”, “description”: “Expense amount”, “type”: “Float”, “required”: |
| | | | | true}, {“name”: “date”, “description”: “Expense date”, “type”: “Date”, |
| | | | | “required”: true}, {“name”: “merchant”, “description”: “Merchant |
| | | | | name”, “type”: “String”, “required”: true}, {“name”: “location”, |
| | | | | “description”: “Location of the expense”, “type”: “String”, “required”: |
| | | | | false}] |
| | | | - | Action type: API_CALL |

| | |
|---|---|
| • | “Get_Expense_Details”: |

| | |
|---|---|
| - | Agent: Expense agent |
| - | Description: Retrieve details of a specific expense |
| - | args JSON schema: [{“name”: “expense_id”, “description”: “Expense |
| | ID”, “type”: “Integer”, “required”: true}] |

| | |
|---|---|
| • | “Update_Expense”: |

| | |
|---|---|
| - | Agent: Expense agent |
| - | Description: Update an existing expense |
| - | args JSON schema: [{“name”: “expense_id”, “description”: “Expense |
| | ID”, “type”: “Integer”, “required”: true}, {“name”: “employee_id”, |
| | “description”: “Employee ID”, “type”: “Integer”, “required”: true}, |
| | {“name”: “amount”, “description”: “Expense amount”, “type”: “Float”, |
| | “required”: true}, {“name”: “date”, “description”: “Expense date”, |
| | “type”: “Date”, “required”: true}, {“name”: “merchant”, “description”: |
| | “Merchant name”, “type”: “String”, “required”: true}, {“name”: |
| | “location”, “description”: “Location of the expense”, “type”: “String”, |
| | “required”: false}] |
| - | type: API_CALL |

| | |
|---|---|
| • | “Delete_Expense”: |

| | |
|---|---|
| - | Agent: Expense agent |
| - | Description: Delete an expense |
| - | args JSON schema: [{“name”: “expense_id”, “description”: “Expense |
| | ID”, “type”: “Integer”, “required”: true}] |
| - | Action type: API_CALL |

| | |
|---|---|
| • | “Get_All_Expenses”: |

| | |
|---|---|
| - | Agent: Expense agent |
| - | Description: Get all expenses for a given employee ID |
| - | args JSON schema: [{“name”: “employee_id”, “description”: |
| | “Employee ID”, “type”: “Integer”, “required”: true}] |
| - | Action type: API_CALL |

| | |
|---|---|
| • | “Get_Expense_Categories”: |

| | |
|---|---|
| - | Agent: Expense agent |
| - | Description: Get all expense categories |
| - | JSON schema: [ ] |
| - | Action type: API_CALL |

| | |
|---|---|
| • | “Expense_FAQ”: |

| | |
|---|---|
| - | Agent: Expense knowledge agent |
| - | Description: The document provides answers to expenses submission |
| | related FAQ: expense reimbursement policies, documentation |
| | requirements, approval processes, and timelines for submitting expense |
| | reports. |
| - | args JSON schema: [ ] |
| - | Action type: KNOWLEDGE |

| | |
|---|---|
| • | “OOD_Action”: |

| | |
|---|---|
| - | Agent: OOD agent |
| - | Description: No matching action for the given question |
| - | args JSON schema: [ ] |
| - | Action type: OOD |

| | |
|---|---|
| Execution Plan | [{ |
| | “action”: “Create_Expense”, |
| | “agent”: “Expense agent”, |
| | “args”: { |
| | “employee_id”: 765943, |
| | “amount”: null, |
| | “date”: null, |
| | “merchant”: “Burger King”, |
| | “location”: null |
| | }] |

As a particular example, the routing engine 304 receives the context information and candidate actions listed in Table 2 as part of a prompt transmitted to the routing engine 304. The input 302 can be an indication the user wants to create an expense, or it may a continuation of the conversation listed with the conversation history in Table 2. Each candidate action has an associated agent, description, JSON schema, and action type. The JSON schema may contain input argument slots with specified types that are required or optional. As an example, the “Get Expense Details” action has an associated JSON schema with one input argument slot for an expense ID that is an integer and is required. Some actions such as “Get Expense Categories” have an associated schema without any input argument slots.

The routing engine 304 may use the candidate actions to form an input prompt for a generative artificial intelligence model. The generative artificial intelligence model may be or be included in generative artificial intelligence models 310, which may include one or more generative models such as LLMs. The routing engine 304 may be communicatively coupled with the generative artificial intelligence models 310 via a common language model interface layer (CLMI layer 312). The CLMI layer 312 may be an adapter layer that can allow the routing engine 304 to call a variety of different generative artificial intelligence models that may be included in the generative artificial intelligence models 310. For example, the routing engine 304 may generate an input prompt and may provide the input prompt to the CLMI layer 312 that can convert the input prompt into a model-specific input prompt for being input into a particular generative artificial intelligence model. The routing engine 304 may receive output from the particular generative artificial intelligence model that can be used to generate an execution plan. The output may be or include the execution plan. In other embodiments, the output may be used as input by the routing engine 304 to allow the routing engine 304 to generate the execution plan. The output may include a list that includes one or more executable actions based on the utterance included in the input 302. In some embodiments, the execution plan may include an ordered list of actions to execute for addressing the input 302.

In some instances, the routing engine 304 may perform slot-filling to supplement any information required by the execution engine 314 to execute the execution plan. In some examples, the output of the routing engine 304 to be sent to the execution engine 314 can be in a JSON schema format. The output may have an associated schema with specified key-value pairs required to pass to the execution engine 314 and the routing engine 304 can determine if any information needed for a selected action is missing. The routing engine 304 may use the conversation history, text from the input 302, the context or any combination thereof to determine the missing information. For example, an action may require information related to the current date and the routing engine 304 can retrieve the current data from the input 302 or from available information within a context. The routing engine 304 may tailor an action to a user by identifying user preferences and filling input argument slots within a schema according to the user preferences.

As a particular example, the routing engine 304 may use the contextual information listed in Table 2 and the input 302 to select the “Create Expense” action among the candidate actions listed in Table 2. “Create Expense” is associated with an API call as its action type and is associated with a JSON schema with input arguments including a required integer employee ID, a required float expense amount, a required date formatted as type date, a required string merchant name, and an optional string describing the location of the expense. The routing engine 304 retrieves the employee ID from the user profile data retrieved with the contextual information and can determine the merchant by looking at the conversation history and recognizing the user previously uttered “Burger King was the merchant.” The routing engine 304 may be unable to determine the remaining input argument slots and instead sets their values to null. The routing engine 304 generates an execution plan as listed in Table 2 including the action, agent, and arguments for the schema.

The routing engine 304 can transmit the execution plan to the execution engine 314 for executing the execution plan. The routing engine 304 may transmit the execution plan along with any information required by the execution engine 314. The execution engine 314 may perform an iterative process for each executable action included in the execution plan. For example, the execution engine 314 may, for each executable action, identify an action type, may invoke one or more states for executing the action type, and may execute the executable action using an asset to obtain an output. The execution engine 314 may be communicatively coupled with an action executor 316 that may be configured to perform at least a portion of the iterative process. For example, the action executor 316 can identify one or more action types for each executable action included in the execution plan. In a particular example, the action executor 316 may identify a first action type 318a for a first executable action of the execution plan. The first action type 318a may be or include a semantic action such as summarizing text or other suitable semantic action. Additionally or alternatively, the action executor 316 may identify a second action type 318b for a second executable action of the execution plan. The second action type 318b may involve invoking an API such as an API for making an adjustment to an account or other suitable API. Additionally or alternatively, the action executor 316 may identify a third action type 318c for a third executable action of the execution plan. The third action type 318c may be or include a knowledge action such as providing an answer to a technical question or other suitable knowledge action. In some embodiments, the third action type 318c may involve making a call to at least one generative artificial intelligence model of the generative artificial intelligence models 310 to retrieve specific knowledge or a specific answer. In other embodiments, the third action type 318c may involve making a call to the semantic context and memory store 306 or other knowledge documents.

In some instances, the execution engine 314 may not receive all of the information required by the action executor 316 to perform a requested action. The execution engine 314 may instead generate an execution failed status and the execution failed status may be sent to the response engine 320. As a particular example, the execution engine 314 may receive the execution plan listed in Table 2. The arguments for amount, date, and location for the “Create Expense” action in the execution plan are set to null. According to the JSON schema associated with the “Create Expense” action, amount and date are required arguments. A call to an API without the required argument can fail, and the execution engine 314 may indicate the missing arguments in an execution status or attempt to call the API and generate an execution status based on the output of the API call.

The action executor 316 may continue the iterative process based on the action types indicated by the executable actions included in the execution plan. Once the action executor 316 identifies the action types, the action executor 316 may identify and/or invoke one or more states for each executable action based on the action type. A state of an action may involve an indication of if or whether an action can be or has been executed. For example, the state for a particular executable action may include “preparing” “ready” “executing” “success” “failure” or any other suitable states. The action executor 316 can determine, based on the invoked state of the executable action, whether the executable action is ready to be executed, and, if the executable action is not ready to be execute, the action executor 316 can identify missing information or assets required for proceeding with executing the executable action. In response to determining that the executable action is ready to be executed, and in response to determining that no dependencies exist (or existing dependencies are satisfied) for the executable action, the action executor 316 can execute the executable action to generate an output.

The action executor 316 can execute each executable action, or any subset thereof, included in the execution plan to generate a set of outputs. The set of outputs may include knowledge outputs, semantic outputs, API outputs, and other suitable outputs. The action executor 316 may provide the set of outputs to an output engine 320. The output engine 320 may be configured to generate a second input prompt based on the set of outputs. The second input prompt can be provided to at least one generative artificial intelligence model of the generative artificial intelligence models 310 to generate a response 322 to the input 302. The output engine 320 may make a call to the at least one generative artificial intelligence model to cause the at least one generative artificial intelligence model to generate the response 322, which can be provided to the user in response to the input 302.

In some instances, the response engine 320 may receive an execution failed status from the execution engine 314. The execution failed status may contain information about why the execution engine 314 was unable to complete an action. The response engine 320 may produce a response 322 to the user indicating the agent requires supplemental information to complete an action. The response 322 may request the user to input the required information. In some examples, the response 322 may indicate that an action cannot be completed and may provide a reason indicating why the action cannot be completed. In some examples, the response 322 may be sent to a user before an action is executed and may ask a user to confirm details of an execution plan. As a particular example, the response engine 320 can request the expense amount and date from the user to complete the “Create Expense” action as listed in Table 2. Upon receiving the requested expense amount from the user, the routing engine 304 can update the execution plan.

In some embodiments, the at least one generative artificial intelligence model used to generate the response 322 may be similar or identical to, or otherwise the same model, as the at least one generative artificial intelligence model used to generate output for generating the execution plan.

### Training, Testing, and Using One or More Machine Learning Models

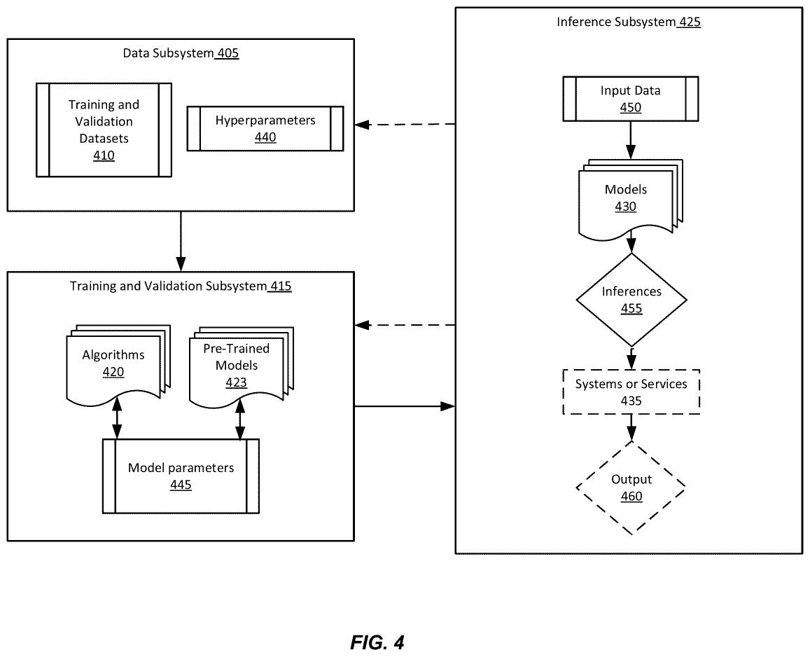

FIG. 4 shows a block diagram of an AI Platform 400 comprising several subsystems that work together to train, validate, and implement one or more machine learning models in accordance with various embodiments. The AI Platform 400 may be executed as part of the digital assistant, Agentic-AI environment or system, and/or AI agent described in FIGS. 1, 2, and 3 to train or fine-tune one or more machine learning models (e.g., one or more generative models) with training data—and deploy and use said one or more machine learning models as described herein.

The AI Platform 400 comprises a data subsystem 405 for collecting, generating, preprocessing, and labeling of training and validation datasets 410, training and validation subsystem 415 that facilitates the training and validation of one or more machine learning algorithms 420 or one or more pre-trained machine learning models 423, and inference subsystem 425 for deploying and implementing one or more trained machine learning models 430 independently or in combination with one or more other systems or services 435 for downstream processes.

As used herein, machine learning algorithms (also described herein as simply algorithm or algorithms) are procedures that are run on datasets (e.g., training and validation datasets) and perform pattern recognition on datasets, learn from the datasets, and/or are fit on the datasets. Examples of machine learning algorithms include linear and logistic regression, decision trees, artificial neural networks, k-means, transformer architectures with attention mechanisms, and k-nearest neighbor. In contrast, machine learning models (also described herein as simply model or models) are the output of the machine learning algorithms and are comprised of model data and a prediction algorithm. In other words, the machine learning model is the program that is saved after running a machine learning algorithm on training data and represents the rules, numbers, and any other algorithm-specific data structures required to make inferences. For example, a linear regression algorithm may result in a model comprised of a vector of coefficients with specific values, and a transformer architecture with attention mechanisms may result in a LLM that utilizes self-attention mechanisms, allowing the model to weigh the importance of different words in a sentence when making predictions.

In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

### Data Subsystem

Data subsystem 405 is used to collect, generate, preprocess, and label data to be used to train and validate one or more machine learning algorithms 420 or one or more pre-trained machine learning models 423. The data collection can include exploring various data sources such as public datasets, private data collections, or real-time data streams, depending on a project's needs. In some instances, a data source is a public or online repository of information or examples pertinent to a general or target domain space (e.g., Java codebase or code repository). Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space (e.g., Java codebase or code repository). Once a data source is identified, data subsystem 405 can be used to collect data through appropriate methods such as downloading from online repositories, web scraping, using APIs for real-time data, creating datasets through surveys and requests for access, or by running programs or scripts. The acquired raw data may be further preprocessed to generate the training and validation datasets 410.

In some instances, raw data (e.g., text scripts and associated audio) may be generated as opposed to being collected or acquired. Data generating may comprise data synthesis and/or data augmentation. Different data synthesis and/or data augmentation techniques may be implemented by the data subsystem 405 to generate data to be used for the training and validation subsystem 415. Data synthesizing involves creating entirely new data points from scratch. Data synthesis may be used when real data is insufficient, too sensitive to use, or when the cost and logistical barriers to obtaining more real data are too high. The synthesized data should be realistic enough to effectively train a machine learning model, but distinct enough to comply with regulations (e.g., copyright and data privacy), if necessary. Data augmentation, on the other hand, refers to techniques used to artificially expand the size of a dataset by creating modified versions of existing data examples. The primary goal of data augmentation is to increase variation in the data in order to make the model more robust to variations it might encounter in the real world, thereby improving its ability to generalize from the training data to unseen data. This is especially common in image and speech recognition tasks but is applicable to other data types as well. For images, data augmentation may include rotations, flipping, scaling, or altering the lighting conditions. For text, data augmentation may include synonyms replacement, back translation, or sentence shuffling. For audio, data augmentation may include changes made to pitch, speed, or background noise.

Preprocessing may be implemented by the data subsystem 405, serving as a bridge between raw data acquisition and effective model training. The primary objective of preprocessing is to transform the raw data into a format that is more suitable and efficient for analysis, ensuring that the data fed into machine learning algorithms or pretrained models is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve.

Other raw data preprocessing techniques that may be utilized include data cleaning, normalization, feature extraction, dimensionality reduction, and the like. Data cleaning may involve removing duplicates, filling in missing values, or filtering out outliers to improve data quality. Normalization involves scaling numeric values to a common scale without distorting differences in the ranges of values, which helps prevent biases in the model due to the inherent scale of features. Feature extraction involves transforming the input data into a set of useable features, possibly reducing the dimensionality of the data in the process. For instance, in audio analysis, feature reduction techniques such as Principal Component Analysis (PCA), Linear Discriminant Analysis (LDA), t-Distributed Stochastic Neighbor Embedding (t-SNE), Non-Negative Matrix Factorization (NMF), and feature selection can be used for simplifying the representation of audio signals while retaining the most relevant information for tasks like classification, recognition, or synthesis. These techniques not only help in reducing the computational load on the model but also in mitigating issues like overfitting by simplifying the data without losing critical information.

In the instance that AI Platform 400 is used for supervised or semi-supervised learning of machine learning models, labeling techniques can be implemented as part of the data collection. The quality and accuracy of data labeling directly influence the model's performance, as labels serve as the definitive guide that the model uses to learn the relationships between the input features and the desired output. Particularly in complex domains such as image analysis, natural language processing, or medical diagnosis, precise and consistent labeling is important because it provides the ground truth or target outcomes against which the model's predictions are compared and adjusted during training. Effective labeling ensures that the model is trained on correct and clear examples, thus enhancing its ability to generalize from the training data to real-world scenarios. In some instances, the annotation labels and ground truth values (labels) are appended or annotated within the raw data. For example, when the raw data includes text scripts, the labels may include the one or more spans and corresponding named entities.

Labeling techniques can vary significantly depending on the type of data and the specific requirements of the project. Manual labeling, where human annotators label the data, is one method that can be used. This approach may be useful when a detailed understanding and judgment are required, such as in labeling medical text or categorizing text data where context and subtlety are important. However, manual labeling can be time-consuming and prone to inconsistency, especially with a large number of annotators. To mitigate this, semi-automated labeling tools may be used as part of data subsystem 405 to pre-label data using algorithms, which human annotators may then review and correct as needed. Another approach is active learning, a technique where the model being developed is used to label new data iteratively. The model suggests labels for new data points, and human annotators may review and adjust certain predictions such as the most uncertain predictions. This technique optimizes the labeling effort by focusing human resources on a subset of the data, e.g., the most ambiguous cases, improving efficiency and label quality through continuous refinement.

Once collected, generated, preprocessed, and/or labeled, the data may then be split into the training and validation datasets 410. The training and validation datasets 410 may comprise the raw data and/or the preprocessed data. The training and validation datasets 410 are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. In some instances, the splitting is performed such that 70% of the training and validation datasets 410 are for training, 10% are for validation, and 20% are for testing. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

Data subsystem 405 is also used for collecting, generating, setting, or implementing model hyperparameters 440 for the training and validation subsystem 415. The hyperparameters control the overall behavior of the models. Unlike model parameters 445 that are learned automatically during training, hyperparameters 440 are set before training begins and have a significant impact on the performance of the model. For example, in a neural network such as that of an LLM, hyperparameters include the learning rate, number of layers, number of neurons/nodes per layer, activation functions, convolution kernel width, the number of kernels for a model, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

### Training, Validation, and Testing

The training and validation subsystem 415 is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries are utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models 430 or fine-tuning is subsequent training phases for fine-tuning machine learning models 430 where the model learns to make predictions or decisions based on training data provided from the training and validation datasets 410. During this phase, the model iteratively adjusts its internal model parameters 445 to achieve a preset optimization condition. In a supervised machine learning training process, the preset optimization condition can be achieved by minimizing the difference between the model output (e.g., predictions, classifications, or decisions) and the ground truth labels in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and validation subsystem 415, the training subset of data is input into the machine learning algorithms 420 or pre-trained models 423 to find a set of model parameters 445 (e.g., weights, coefficients, trees, feature importance, and/or biases) that minimizes or maximizes an objective function (e.g., a loss function, a cost function, a contrastive loss function, a cross-entropy loss function, an Out-of-Bag (OOB) score, etc.). To train the machine learning algorithms 420 or pre-trained models 423 to achieve accurate predictions, “errors” (e.g., a difference between a predicted label and the ground truth label) need to be minimized. In order to minimize the errors, the model parameters can be configured to be incrementally updated by minimizing the objective function over the training phase (“optimization”). Various different techniques may be used to perform the optimization. For example, to train machine learning algorithms or pre-trained models such as a neural network, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters 445 in a manner as to minimize or maximize an objective function. This cycle is repeated until a desired state (e.g., a predetermined minimum value of the objective function) is reached.

The training phase is driven by three primary components: the model architecture (which defines the structure of the algorithm(s) 420 or pretrained model(s) 423), the training data (which provides the examples from which to learn), and the learning algorithm (which dictates how the model adjusts its model parameters). The goal is for the model to capture the underlying patterns of the data without memorizing specific examples, thus enabling it to perform well on new, unseen data.

The model architecture is the specific arrangement and structure of the various components and/or layers that make up a model. In the context of a neural network, the model architecture may include the configuration of layers in the neural network, such as the number of layers, the type of layers (e.g., convolutional, recurrent, fully connected), the number of neurons in each layer, and the connections between these layers. In the context of a LLM comprised of a transformer architecture, which utilizes self-attention mechanisms to process and generate human-like text. The transformer model comprises an encoder-decoder structure, where the encoder processes the input text, and the decoder generates the output. The self-attention mechanism allows the model to weigh the importance of different words in a sentence, capturing long-range dependencies and contextual relationships. This architecture enables the model to handle large-scale data and understand complex language patterns. During training, the optimization algorithm such as Adam is used to minimize the loss function through backpropagation, and regularization techniques like dropout are employed to prevent overfitting, resulting in a robust and efficient language model capable of performing various natural language processing tasks such as predicting the ADR relations.

The model architecture also encompasses the choice and arrangement of features and algorithms used in various models, such as neural networks and transformers. The architecture determines how input data is processed and transformed through various computational steps to produce the output. The model architecture directly influences the model's ability to learn from the data effectively and efficiently, and it impacts how well the model performs tasks such as classification, regression, or prediction, adapting to the specific complexities and nuances of the data it is designed to handle.

The learning algorithm is the overall method or procedure used to adjust the model parameters 445 to fit the data. It dictates how the model learns from the data provided during training. This includes the steps or rules that the algorithm follows to process input data and make adjustments to the model's internal parameters (e.g., weights in neural networks) based on the output of the objective function. Examples of learning algorithms include gradient descent, backpropagation for neural networks, and splitting criteria in decision trees.

Various techniques may be employed by training and validation subsystem 415 to train machine learning models 430 using the learning algorithm, depending on the type of model and the specific task. For supervised learning models, where the training data includes both inputs and expected outputs (e.g., ground truth labels), gradient descent is a possible method. This technique iteratively adjusts the model parameters 445 to minimize or maximize an objective function (e.g., a loss function, a cost function, a contrastive loss function, etc.). The objective function is a method to measure how well the model's predictions match the actual labels or outcomes in the training data. It quantifies the error between predicted values and true values and presents this error as a single real number. The goal of training is to minimize this error, indicating that the model's predictions are, on average, close to the true data. Common examples of loss functions include mean squared error for regression tasks and cross-entropy loss for classification tasks.

The adjustment of the model parameters 445 is performed by the optimization function or algorithm, which refers to the specific method used to minimize (or maximize) the objective function. The optimization function is the engine behind the learning algorithm, guiding how the model parameters 445 are adjusted during training. It determines the strategy to use when searching for the best weights that minimize (or maximize) the objective function. Gradient descent is a primary example of an optimization algorithm, including its variants like stochastic gradient descent (SGD), mini-batch gradient descent, and advanced versions like Adam or RMSprop, which provide different ways to adjust learning rates or take advantage of the momentum of changes. For example, in training a neural network, backpropagation may be used with gradient descent to update the weights of the network based on the error rate obtained in the previous epoch (cycle through the full training dataset). Another technique in supervised learning is the use of decision trees, where a tree-like model of decisions is built by splitting the training dataset into subsets based on an attribute value test. This process is repeated on each derived subset in a recursive manner called recursive partitioning.

In unsupervised learning, where training data does not include labels, different techniques are used. Clustering is one method where data is grouped into clusters that maximize the similarities of data within the same cluster and maximize the differences with data in other clusters. The K-Means algorithm, for example, assigns each data point to the nearest cluster by minimizing the sum of distances between data points and their respective cluster centroids. Another technique, Principal Component Analysis (PCA), involves reducing the dimensionality of data by transforming it into a new set of variables, the principal components, which are uncorrelated and ordered so that the first few retain most of the variation present in all of the original variables. These techniques help uncover hidden structures or patterns in the data, which can be essential for feature reduction, anomaly detection, or preparing data for further supervised learning tasks.

Validating is another phase of developing machine learning models 430 where the model is checked for deficiencies in performance and the hyperparameters 440 are optimized based on validation data provided from the training and validation datasets 410. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

An exemplary validation process includes iterative operations of inputting the validation subset of data into the trained algorithm(s) using a validation technique such as K-Fold Cross-Validation, Leave-one-out Cross-Validation, Leave-one-group-out Cross-Validation, Nested Cross-Validation, or the like, to fine-tune the hyperparameters and ultimately find the optimal set of hyperparameters. In some instances, a 5-fold cross-validation technique may be used to avoid overfitting the trained algorithm and/or to limit the number of selected features per split to the square-root of the total number of input features. In some instances, training dataset is split into 5 equal-size cohorts (or about equal-size), and every four of the cohorts are used to train an algorithm to generate five models (e.g, cohorts #1, 2, 3, and 4 are used to train and generate model 1, cohorts #1, 2, 3, and 5 are used to train and generate model 2, cohorts #1, 2, 4, and 5 are used to train and generate model 3, cohorts #1, 3, 4, and 5 are used to train and generate model 4, and cohorts #2, 3, 4 and 5 are used to train and generate model 5). Each model is evaluated (or validated) using the unused cohort in the training (e.g., for model 5, cohort #1 is used for validation). The overall performance of the training can be evaluated by an average performance of the five models. K-fold cross-validation provides a more robust estimate of a model's performance compared to a single training/validation split because it utilizes the entire dataset for both training and evaluation and reduces the variance in the performance estimate.

Once a machine learning model has been trained and validated, it undergoes a final evaluation using test data provided from the training and validation datasets 410, which is a separate subset of the data that has not been used during the training or validation phases. This step is crucial as it provides an unbiased assessment of the model's performance in simulating real-world operation. The test dataset serves as new, unseen data for the model, mimicking how the model would perform when deployed in actual use. During testing, the model's predictions are compared against the true values in the test dataset using various performance metrics such as accuracy, precision, recall, and mean squared error, depending on the nature of the problem (classification or regression). This process helps to verify the generalizability of the model-its ability to perform well across different data samples and environments-highlighting potential issues like overfitting or underfitting and ensuring that the model is robust and reliable for practical applications. The machine learning models 430 are fully validated and tested once the output predictions have been deemed acceptable by user defined acceptance parameters. Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

### Inference Phase for Machine Learning Models

The inference subsystem 425 is comprised of various components for deploying the machine learning models 430 in a production environment (e.g., use as cloud service as described with respect to FIGS. 11-15). Deploying the machine learning models 430 includes moving the models from a development environment (e.g., the training and validation subsystem 415, where it has been trained, validated, and tested), into a production environment where it can make inferences on real-world data (e.g., input data 450). This step typically starts with the model being saved after training, including its parameters and configuration such as final architecture and hyperparameters. It is then converted, if necessary, into a format that is suitable for deployment, depending on the deployment environment. For instance, a model trained in a scientific computing environment such as Python might be converted into a Java-friendly format for integration into a larger enterprise application.

Deployment can be conducted on various platforms, including on-premises servers or cloud environments like Oracle's Cloud Infrastructure (OCI), as described in greater detail with respect to FIGS. 11-15. In some instances, a portion of or the digital assistant, Agentic-AI environment or system, and/or AI agent described in FIGS. 1, 2, and 3 can be bundled into an application using a software framework such as Gradio or LangChain, which is executable on one or more of the various platforms. A Gradio application is an open-source Python package that allows a user to quickly build a demo or web application for their machine learning model, API, or any arbitrary Python function (e.g., a could service application). LangChain provides utilities for integrating generative models into applications. The application can be built to enable users to play around with the training data generator in a playground mode, as well as generate training dataset in bulk, train models using the training dataset, and use the models in a production environment.

Once deployed, the model is ready to receive input data 450 and return outputs (e.g., inferences 455). In some instances, the model resides as a component of a larger system or service (e.g., including additional downstream applications 435). In some instances, the models 430 and/or the inferences 455 can be used by the downstream applications 435 to provide further information. For example, the inferences 455 can be used to for converting text to audio, detecting audio, converting audio to text, executing code, and the like. The downstream applications can be configured to generate an output 460. In some instances, the output 460 comprises a report including inferences 455 and information generated by the downstream applications 435.

To manage and maintain its performance, a deployed model may be continuously monitored to ensure it performs as expected over time. This involves tracking the model's prediction accuracy, response times, and other operational metrics. Additionally, the model may require retraining or updates based on new data or changing conditions in the environment it is applied in. This can be useful because machine learning models can drift over time due to changes in the underlying data they are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Structuring-Based Key Information Extraction

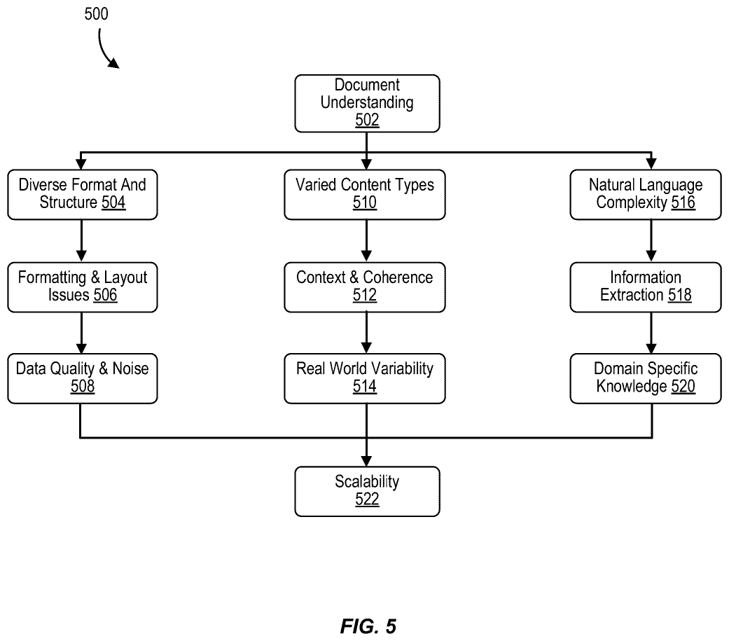

FIG. 5 can illustrate various types of problems and challenges that may be encountered in the field of Document Understanding 502. In different embodiments, systems and methods described in the present disclosure may be configured to address, mitigate, or adapt to any combination of these challenges, either individually or in aggregate, across a wide variety of document types and processing scenarios.

A first category of problems may relate to Diverse Format and Structure 504. Documents encountered in real-world applications can be presented in an extensive range of formats and structural layouts. For example, documents may be generated by computers or handwritten, and may be structured as reports, emails, forms, tables, or include nested fields or mixed content. Some documents may contain multilingual text or symbols, and may vary in terms of font, color, or inclusion of annotations. Embodiments may address Diverse Format and Structure 504 by supporting flexible schema definitions, adaptive parsing strategies, or learning-based recognition of new formats.

Formatting & Layout Issues 506 may refer to difficulties associated with non-uniform or complex visual arrangements within documents. For instance, documents may contain multi-column text, embedded images, tables with merged cells, rotated or skewed text, or inconsistent spacing and alignment. An embodiment may employ image analysis, layout reconstruction, or spatial reasoning to interpret and normalize these diverse layouts. In some cases, formatting and layout issues may be compounded by the presence of overlays, stamps, or watermarks, and solutions may include preprocessing techniques to isolate or compensate for such elements.

Data Quality & Noise 508 may represent problems arising from imperfections or inconsistencies in document data. Documents may be degraded due to scanning errors, low-resolution images, ink smudges, faded print, or handwritten annotations. Noise can also include extraneous marks, artifacts, or digital distortion. In some embodiments, systems may include or interface with pre-processing modules that can enhance image quality, perform denoising, or correct for such artifacts prior to information extraction. Data quality issues may also encompass typographical errors or outdated information, which may be addressed by validation rules or reference to external data sources.

Varied Content Types 510 can refer to the presence of multiple types of information within a document, such as text, images, graphics, tables, barcodes, signatures, or embedded multimedia. In some cases, a single document may combine several content types, each requiring a different extraction or interpretation strategy. Embodiments may use multimodal processing techniques, modular extraction pipelines, or content-type-specific models to handle such diversity. Additional configurations may allow for the extension of the system to new or previously unencountered content types.

Context & Coherence 512 may describe the challenge of understanding information in its broader textual or structural context. For example, the meaning of a field or value may depend on its placement within a section, its proximity to related information, or relationships across multiple pages. Embodiments may use contextual language models, reference resolution algorithms, or hierarchical data structures to capture and utilize context and coherence in information extraction.

Real World Variability 514 may refer to the unpredictable or unstructured nature of documents encountered outside controlled or template-based environments. Documents may be missing expected fields, include unanticipated annotations, or be partially incomplete or redacted. Variability may also arise from differences in document age, origin, or user modification. Embodiments may be configured to apply robust extraction methods, fallback heuristics, or adaptive learning to handle such real world variability.

Natural Language Complexity 516 can refer to the ambiguous, context-dependent, or domain-specific nature of human language found in many documents. This may include synonyms, homonyms, technical jargon, abbreviations, idioms, or mixed languages. Documents may include formal or informal language, or switch registers within a single page. Embodiments may use advanced language models, customizable dictionaries, or domain-adaptive parsers to address these complexities.

Information Extraction 518 can refer to the overarching challenge of accurately identifying, extracting, and normalizing key data points, fields, or relationships from documents. This may include tasks such as named entity recognition, table parsing, relationship mapping, or hierarchical field extraction. Embodiments may use rule-based, statistical, or machine-learning-based extraction techniques, either individually or in combination, to achieve accurate and robust information extraction.

Domain Specific Knowledge 520 may describe the requirement to incorporate specialized rules, terminology, or context for documents associated with particular fields, such as legal, financial, or healthcare documents. Such knowledge may include legal citations, medical codes, or industry standards that affect both the recognition and interpretation of document content. Embodiments may integrate domain-specific ontologies, external knowledge bases, or custom extraction rules to address these requirements, and such resources may be updated or extended as new domains are encountered.

Scalability 522 may refer to the need for document understanding systems to efficiently process large volumes of diverse documents while maintaining consistent accuracy and performance. Scalability challenges may relate to computational resource management, distributed processing, or system integration with existing workflows. Embodiments may employ batching, cloud-based architectures, parallel processing, or dynamic resource allocation to address scalability, and may support incremental updates, real-time processing, or offline batch modes as needed.

It should be understood that the challenges illustrated in FIG. 5 may be present in varying degrees and combinations across different document types and application scenarios. Embodiments of the present disclosure can be configured to address, mitigate, or adapt to any subset of these challenges, and additional or alternative challenges may be recognized in future applications. The order, grouping, and classification of challenges in FIG. 5 are illustrative and may be modified, expanded, or rearranged in other embodiments as appropriate for specific use cases or technological developments.

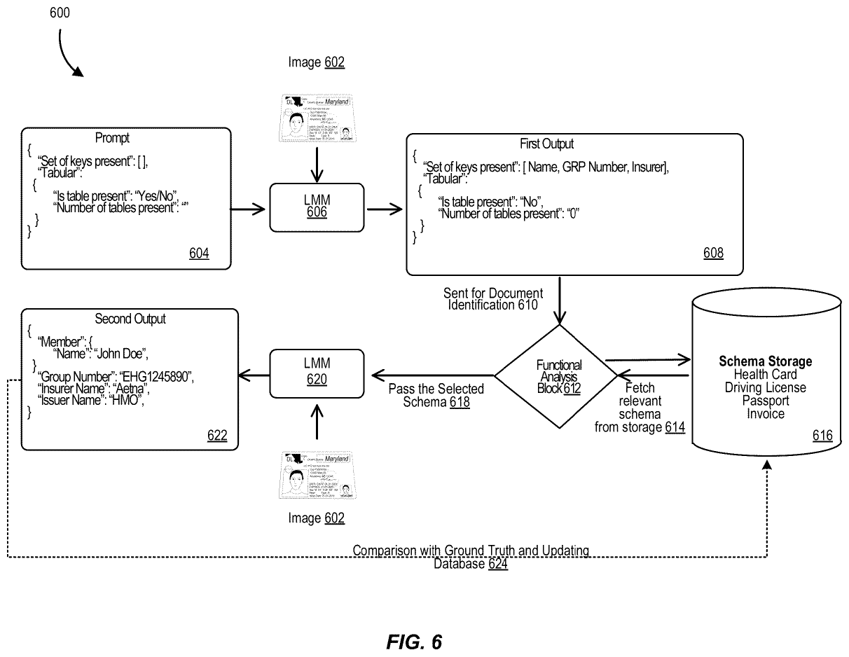

FIG. 6 can illustrate a method or system for addressing document understanding problems using one or more large multimodal models (LMMs) and flexible structural representations. In some embodiments, the process may begin with an Image 602, which can represent any document acquired in an image format. Image 602 may include any form of digital or digitized document image, and embodiments may be configured to accept, process, and analyze a wide variety of image formats and sources. In some examples, Image 602 may be provided as a raster image format, such as JPEG, PNG, BMP, TIFF, GIF, or HEIC, or as a vector-based format, such as SVG or PDF (where the PDF includes embedded images or scanned pages). Image 602 may originate from scanned physical documents, photographs captured by mobile devices or cameras, screenshots from computing devices, fax transmissions, or images extracted from multi-page files such as multi-frame TIFFs or PDF containers. In some embodiments, Image 602 may be compressed, encrypted, watermarked, or may include embedded metadata such as EXIF, XMP, or custom tags. Image 602 may be presented in color, grayscale, or black-and-white, and may vary in resolution, aspect ratio, bit depth, or compression quality. In some cases, Image 602 may include single-page or multi-page documents, and embodiments may be configured to process one or more images individually or in batch. Image 602 may also support formats optimized for different use cases, such as high-resolution archival scans, low-bandwidth thumbnails, or document images processed for OCR. Additional embodiments may be configured to handle proprietary or legacy formats, or to interface with document imaging systems that produce output in custom or domain-specific image formats. The system may be further adapted to perform format conversion, normalization, or preprocessing to accommodate the diverse range of input image types that may be encountered in real-world document understanding scenarios.

A Prompt 604 may be generated or selected for use with the image. Prompt 604 can include any instruction, query, or input text configured to guide the operation of a multimodal model, and may be dynamically constructed, templated, or drawn from a repository of prompts. In some embodiments, Prompt 604 may be customized based on the anticipated document type, source, or user preference, and may include instructions designed to elicit key information, fields, or structures from the document.

Both Image 602 and Prompt 604 may be provided to an LMM 606. LMM 606 can comprise any large multimodal model, which may be implemented using deep learning, transformer architectures, or any model capable of processing and relating visual and textual information. LMM 606 may operate locally, in a distributed fashion, or as a cloud-based service, and may be configured to process single or multiple documents at once.

Upon receiving Image 602 and Prompt 604, LMM 606 may produce a First Output 608. First Output 608 may include any information extracted from the image in response to the prompt, such as candidate keys, detected fields, text regions, or logical groupings of document content. First Output 608 may be structured or unstructured, and may include additional metadata, positional information, or confidence scores depending on the capabilities and configuration of LMM 606.

First Output 608 may be Sent for Document Identification 610, which may be processed by a Functional Analysis Block 612. In various embodiments, Functional Analysis Block 612 may involve analyzing the output from LMM 606 to determine the probable type, class, or characteristics of the input document. Functional Analysis Block 612 may use rule-based logic, machine learning, clustering, or statistical analysis to identify the document type, and may be configured to adaptively refine its decision criteria as new document formats are introduced. Functional Analysis Block 612 may further perform additional analysis, such as detecting the presence of tables, images, or latent fields, or determining which schema or processing pipeline should be used.

Based on the document identification results, the system may Fetch Relevant Schema from Storage 614. This operation may involve retrieving a schema from Schema Storage 616, which may be a local, remote, or distributed repository of schemas. Each schema in Schema Storage 616 can describe the expected fields, data types, required or optional status, default values, aliases, and relationships among elements for a particular document type or class. Schemas may be versioned, modifiable, and extensible, and Schema Storage 616 may support dynamic addition, removal, or updating of schema definitions as document types evolve or user requirements change.

Once an appropriate schema is selected, the system may Pass the Selected Schema 618 to a second LMM 620. In some embodiments, LMM 620 may be the same as, or different from, LMM 606, and may operate on the same or a newly provided instance of Image 602. LMM 620 may be configured to accept both the schema and the image as inputs, and may use the schema to constrain, structure, or enhance the extraction of information from the image. The schema may be provided as a prompt, as a structural template, or as a set of constraints for the LMM, and the manner of integration may vary in different implementations.

Upon processing the image in accordance with the selected schema, LMM 620 may produce a Second Output 622. Second Output 622 can include structured key-value pairs, hierarchically organized fields, tabular data, or any other structured representation of information extracted from the document. In some embodiments, Second Output 622 may be formatted as a JSON object, XML, or other machine-readable structure, and may include metadata, confidence scores, or links to the original document image or schema. In some embodiments, after LMM 620 generates Second Output 622, which may include a set of candidate key-value pairs and optionally associated positional or contextual metadata, the system may construct a graph representation to further model the structure of the document. In these embodiments, each extracted field or entity can be represented as a node in a graph, and edges can be used to encode relationships between fields, such as spatial proximity, logical association, or hierarchical grouping.

The graph representation may be formalized as G=(V, E), where V denotes the set of nodes corresponding to candidate keys or extracted entities, and E denotes the set of edges representing relationships among these nodes. In some cases, the system may assign a weight w(vi) to each node vi to reflect the importance or confidence in the field, and a weight w(vi, vj) to each edge (vi, vj) to reflect the strength or relevance of the relationship between two fields.

The process of structuring and optimizing the extracted information may be formulated as a subgraph selection problem, where the system seeks to identify a subgraph G′⊆G that maximizes a utility function U(G′) over the nodes and edges of the graph. The utility function U(G′) can be defined in various ways to reflect the goals of the extraction process, such as maximizing accuracy, coverage of required fields, or alignment with the target schema. For example:

$$U ( {G}^{′} ) = {\sum }_{{v}_{i} ∈ {G}^{′}}^{n} w ( {v}_{1} ) + {\sum }_{{v}_{i} , {v}_{j} ∈ {G}^{′}}^{n} w ( {v}_{i} , {v}_{j} )$$

where w(vi) represents the importance of node vi and w(vi, vj) represents the strength of the relationship between nodes vi and vj. This graph-based approach may allow the system to robustly resolve ambiguities, identify the most relevant groupings of information, and accurately map complex or nested document structures. In some embodiments, the subgraph selection may be guided by rules, learned models, optimization algorithms, or a combination thereof. The resulting subgraph can be used to generate the final structured output, which may then be compared to ground truth data, used to update the schema storage, or provided to downstream systems in a machine-readable format.

It should be understood that the construction, weighting, and selection of graphs and subgraphs can be performed in various ways depending on the document type, extraction context, or system configuration, and that additional graph-based analyses or optimizations may be employed to further enhance extraction performance.

Optionally, Second Output 622 may undergo a Comparison with Ground Truth and Updating Database 624. This process may involve evaluating the accuracy or completeness of the extracted information by comparing it to known ground truth data, historical extractions, or user-provided corrections. If discrepancies are found, the system may update the schema, extraction logic, or underlying database to improve future performance. Updating may involve adding new fields, modifying data type constraints, or adjusting extraction rules. In some embodiments, this process may store a new or updated schema back in Schema Storage 616, enabling the system to learn from feedback and adapt to new document types or evolving formats over time.

Variations of this process are possible in many embodiments. For example, the sequence and composition of the described blocks may be rearranged, combined, or further subdivided. Multiple instances of LMMs may operate in parallel or in cascade, and schemas may be selected, merged, or synthesized from multiple sources. The process may support batch or real-time document processing, and may include additional modules for security, user feedback, workflow integration, or system monitoring.

It should be understood that the steps and components depicted in FIG. 6 are illustrative and non-limiting, and that embodiments may omit, modify, or augment any of the illustrated elements as appropriate for specific applications, document types, or technological advances.

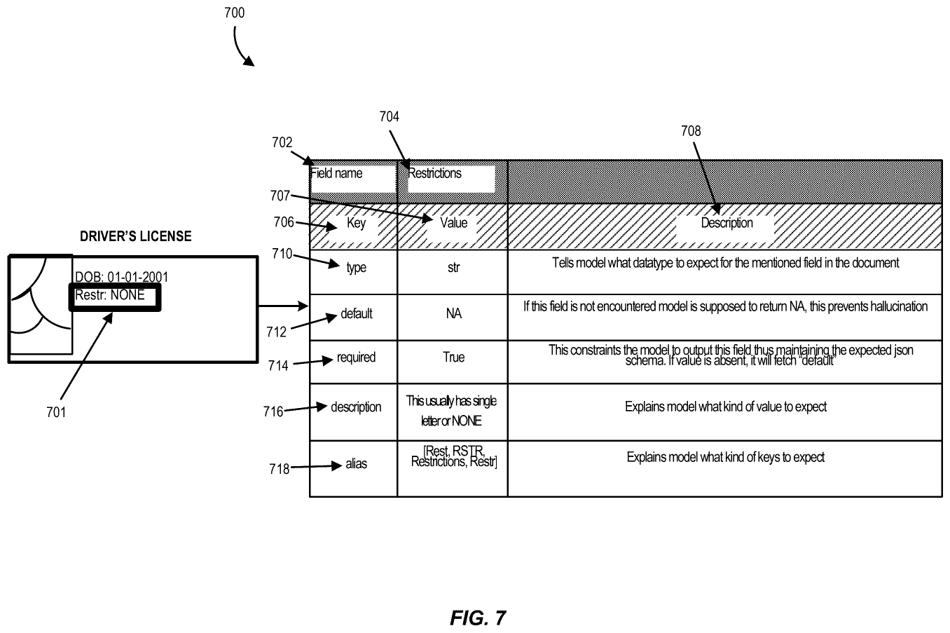

FIG. 7 may illustrate, in accordance with various embodiments, one example of a generalized schema 700 that can be used by a document understanding system to structure and guide the extraction of key information from documents such as driver's licenses, invoices, health cards, or other record types. The schema 700 shown in FIG. 7 is provided as a representative example and may be adapted, extended, or otherwise modified for use with any document type or processing scenario.

In the illustrated embodiment, schema 700 may define a plurality of fields, each field providing structural and semantic guidance for information extraction. For example, a portion 701 of schema 700 can correspond to a specific field or data item present on a document, such as the “Restr: NONE” entry from a driver's license. In other embodiments, other document fields or sections may be represented in a similar fashion, and schema 700 may contain any number of such field definitions.

Field name 702 may indicate the label or identifier associated with a particular field to be extracted from the document. In this example, the field name may be “Restrictions,” but alternative or additional field names may be used depending on the schema or document type.

Restrictions 704 may refer to constraints or rules that are associated with the field. These may include permissible values, formats, regular expressions, or other validation criteria. In some embodiments, restrictions 704 may be expressed as a list, a range, or a logical expression, and may be used by the extraction model to validate or filter candidate values.

Key 706 can represent the canonical or normalized name of the field as used within the schema, database, or output structure. Value 707 may denote the extracted value corresponding to the key, as identified on the document by the system or model. Description 708 can provide additional explanatory or contextual information about the field, its meaning, or its expected usage. This description may be used to help guide the extraction process or to clarify ambiguous cases.

Type 710 may specify the expected data type for the field value, such as string, integer, float, date, enumeration, or any other appropriate type. In the illustrated example, the type is “string,” but any data type suitable for the field may be specified. Default 712 may indicate a default value to be used when the field is not present or cannot be reliably extracted from the document. In this example, the default is “NA,” signifying “not available” or “not applicable,” but other default values may be specified as appropriate for the domain or use case.

Field required 714 may indicate whether the field is mandatory or optional within the schema. In some embodiments, required may be a Boolean value (such as True or False), a conditional statement, or a rule based on document type or context. This can guide how strictly the extraction system enforces the presence of the field in the output.

Description 716 may provide a concise explanation, instruction, or example related to the field, such as expected value formats or typical content (for example, “This usually has single letter or NONE”). This description may be used internally by the extraction model, displayed to users, or used to generate documentation for the schema.

Alias 718 may contain a list of alternative field names, abbreviations, or synonyms by which the field may be referenced or labeled in different documents or formats. In the example, aliases for “Restrictions” include “Rest,” “RSTR,” and “Restr.” Aliases 718 may allow the extraction system to recognize and correctly map varying field names, label conventions, or language differences to the canonical schema field.

In various embodiments, each field in schema 700 may be described using some or all of these elements, and additional metadata, constraints, or relationships may also be included. The schema may be represented in any suitable data structure or format, such as JSON, XML, YAML, or a relational database table, and may support nested fields, arrays, or complex types as needed for more sophisticated documents.

Schema 700, as depicted in FIG. 7, can be directly tied to the workflow illustrated in FIG. 6. During the step labeled “fetch relevant schema from storage” 614, the system may retrieve a schema definition such as schema 700 from a schema storage 616. The selection of which schema to retrieve may be based on the document identification performed earlier in the process (e.g., recognizing the document as a driver's license, invoice, or health card).

Once the appropriate schema has been fetched, the system may proceed to “pass the selected schema” 618, providing the schema (such as the one illustrated in FIG. 7) as input to LMM 620, possibly along with the original document image. Passing the selected schema may involve supplying the schema as a prompt, as a structured input, or as a set of extraction instructions, depending on the implementation of LMM 620. The schema's structure-such as its field names, types, required status, aliases, default values, and descriptions—may be used by the LMM to guide the extraction process, constrain the output format, validate candidate values, and resolve ambiguities or variations in document layout and labeling.

In some embodiments, the process of passing the schema may include translating the schema into a format compatible with the LMM's input requirements, combining it with a textual or templated prompt, or integrating it into a multi-stage extraction workflow. The LMM may use the schema to enforce that only recognized fields are extracted, that values conform to expected types or constraints, and that alternative field names or representations are correctly mapped to the schema's canonical fields.

The output generated by the LMM after being guided by schema 700 can be a structured, reliable, and normalized set of key-value pairs, ready for further processing, validation, or storage. If the output is compared to ground truth or user feedback (as in the “comparison with ground truth and updating database” 624 step in FIG. 6), the schema itself may be updated or refined based on observed extraction performance, allowing the system to adapt to new document variations or evolving requirements.

It should be understood that the schema structure shown in FIG. 7 is illustrative and that additional or alternative fields, metadata, or constraints may be included in different embodiments. The schema may be dynamically generated, manually authored, or learned from data, and may support extensibility and customization for new document types or extraction tasks. Furthermore, the use of aliases, default values, and flexible descriptions may enable robust generalization and adaptability across a wide variety of document layouts, formats, and languages.

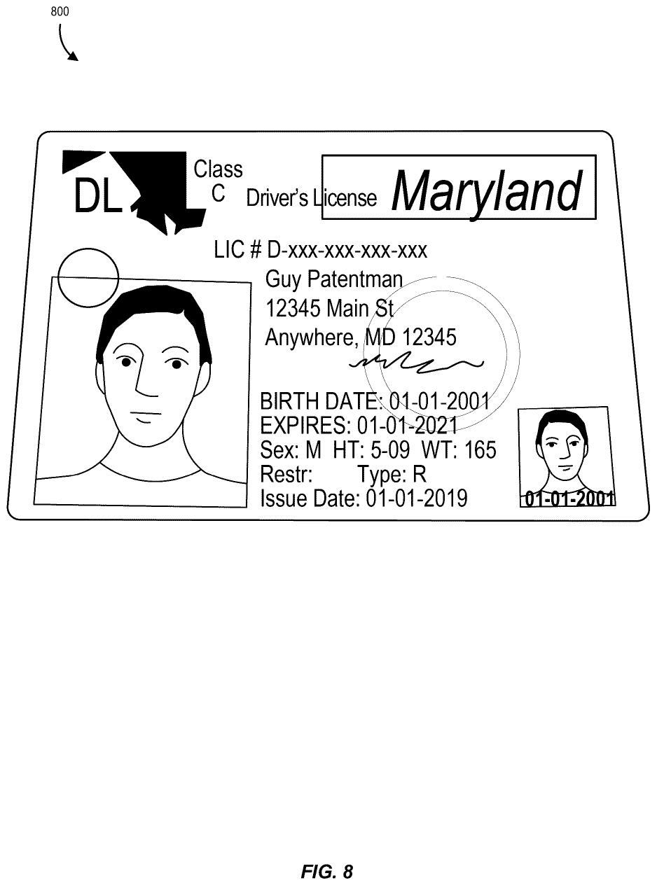

FIG. 8 illustrates an example of a driver's license document image that can be used to describe and explain various approaches to key information extraction in accordance with different embodiments. The driver's license depicted in FIG. 8 may display information in a format that can include, but is not limited to, the following example content: a name such as “Guy Patentman,” an address such as “12345 Main St, Anywhere, MD 12345,” and fields including “BIRTH DATE: 01-01-2001,” “EXPIRES: 01-01-2021,” “Sex: M,” “HT: 5-09,” “WT: 165,” “Restr:,” “Type: R,” and “Issue Date: 01-01-2019.” The arrangement, labeling, and inclusion of information on a driver's license may vary across jurisdictions, document versions, and issuing authorities, and embodiments may be configured to accommodate a wide range of possible layouts, field labels, and value formats.

In some embodiments, directly inferred keys may refer to fields or values that are presented on the document with an explicit label or identifier, enabling straightforward extraction without the need for additional contextual inference or world knowledge. For example, on the license shown in FIG. 8, fields such as “BIRTH DATE: 01-01-2001,” “EXPIRES: 01-01-2021,” “Sex: M,” “HT: 5-09,” “WT: 165,” “Restr:,” “Type: R,” and “Issue Date: 01-01-2019” may be considered directly inferred keys. These fields may appear as clearly labeled key-value pairs, and the extraction system may be configured to recognize the field names, parse the associated values, and map them to the appropriate entries in a target schema. In some implementations, the system may utilize flexible matching to recognize alternative spellings, abbreviations, or visual presentations of field names, such as “Birth Date,” “DOB,” or “Date of Birth.”

Latent keys may refer to values that are present on the document but do not have an explicit, adjacent field label or identifier, necessitating inference based on external knowledge, document layout conventions, or machine learning models. In the example of FIG. 8, the name “Guy Patentman” may be printed in a prominent location, such as near the top of the license, but without an explicit field label such as “Name” or “Holder.” Similarly, the address “12345 Main St, Anywhere, MD 12345” may appear on the document without a corresponding “Address” label. The extraction system may be configured to infer that these values correspond to the “Name” and “Address” fields, respectively, by leveraging spatial positioning, font size or style, document structure heuristics, or training data that models typical layouts for driver's licenses. In some embodiments, latent key identification may be improved by using lists of common field positions, reference templates, or neural network models that have learned associations between document regions and field semantics.

Derived keys may refer to information that is not directly presented on the document but can be calculated or inferred from one or more explicitly extracted fields through logical operations or post-processing. For example, if the “BIRTH DATE” field is successfully extracted as “01-01-2001,” the system may be configured to calculate the “Age” of the license holder by comparing the date of birth to a relevant reference date, such as the current date or the “Issue Date” or “EXPIRES” field. Additional derived keys may include the “Document Validity Period” (calculated as the difference between “Issue Date” and “EXPIRES”), “Is Expired” status (determined by comparing “EXPIRES” to the current date), or eligibility attributes derived from combinations of fields such as age and license type. The logic for deriving such keys may be defined in the schema, implemented as configurable rules, or provided as domain-specific scripts or functions.

The specific handling of each field may vary depending on the document layout, jurisdiction, user requirements, or system configuration. Embodiments may include additional categories, such as composite keys (aggregating multiple values), optional keys (present only in some cases), or ambiguous keys (requiring user confirmation). The extraction system may be further adapted to support documents with overlapping, missing, or variably formatted fields, and may employ feedback mechanisms, confidence scoring, or iterative refinement to improve extraction accuracy.

Although FIG. 8 is described with reference to a driver's license, the concepts of directly inferred, latent, and derived keys may be applied to other document types, such as health cards, invoices, passports, bank statements or utility bills, and the extraction methods may be generalized or customized as appropriate for each scenario. The system may be configured to update its extraction logic, schema definitions, or field inference models as new document layouts or field types are encountered in real-world applications.

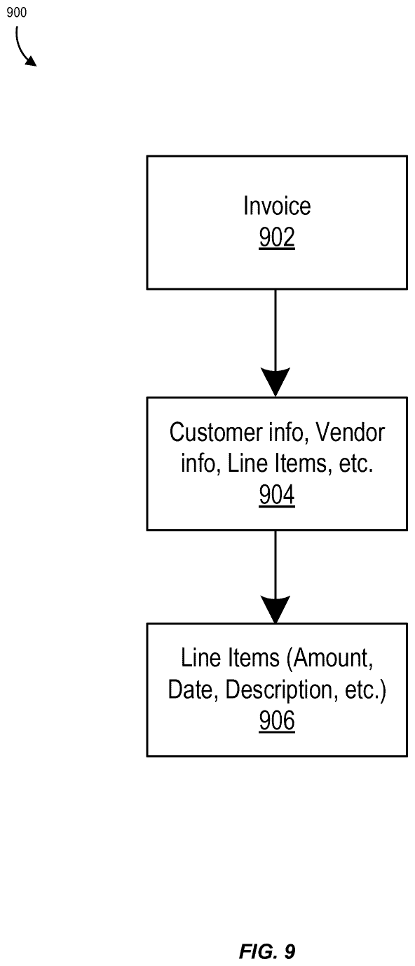

FIG. 9 may illustrate, in accordance with various embodiments, an example of a nested structure that can be present within an invoice document 902 or similar business record. This figure is intended to demonstrate the types of hierarchical and tabular information that may be encountered during automated document understanding and key information extraction processes. The concepts described with reference to FIG. 9 may be applied to invoices, receipts, purchase orders, financial statements, or other documents that include nested, grouped, or repeated fields.

In some embodiments, Invoice 902 may represent the overall document or data record being processed. Invoice 902 may be provided as a digital image, a scanned document, a PDF file, or as structured or semi-structured data in various formats. The layout, field arrangement, and content of Invoice 902 may vary widely depending on the issuing entity, geographic region, business convention, or document version.

Invoice 902 may contain one or more groups of information that can be identified and extracted as logical sections or blocks. For example, Customer info and Vendor info and similar sections 904 may refer to portions of the invoice that contain details about the customer or purchaser and the vendor or seller, respectively. In various embodiments, Customer info may include fields such as customer name, customer address, customer contact information, customer ID, or customer tax identification number. Vendor info may include vendor name, vendor address, vendor contact information, vendor tax identification, and other identifiers or attributes relevant to the supplier. The specific fields present in each group may be defined by a schema, may be variable across different invoice templates, and may be detected by the system using explicit labels, spatial grouping, or learned associations.

Invoice 902 may also include a section or block corresponding to Line Items 906. Line Items 906 may represent a repeating or tabular structure within the invoice, where each line item corresponds to an individual good or service provided as part of the transaction. In some embodiments, Line Items 906 may be represented as a table, a set of rows, a bulleted list, or as a collection of semi-structured entries, depending on the document's layout and formatting. Each line item may include multiple sub-fields or attributes, such as Amount, Date, Description, Quantity, Product Code, Unit Price, Tax, or Discount. The system may be configured to identify the boundaries of the line item section, detect the headers or labels for each column or field, and extract the corresponding values for each item in the list. Line item fields may be nested within the overall invoice structure and may be represented as arrays, objects, or other hierarchical data types in the output schema.

Additional blocks or fields that may be present in Invoice 902 or similar documents can include, but are not limited to, invoice date, due date, purchase order number, billing address, shipping address, payment terms, subtotal, tax amounts, total amount due, currency code, remittance instructions, and notes or comments. Some invoices may include multiple nested or grouped sections, such as multiple billing entities, multiple sets of line items, summary tables, or embedded images or barcodes. The system may be configured to flexibly identify and extract any combination of these fields, using rule-based logic, schema-driven prompting, spatial analysis, or machine learning models, depending on the embodiment.

In some embodiments, the extraction of nested and tabular information from Invoice 902 may be facilitated by a schema that specifies the expected structure, field types, relationships, and constraints for invoices or similar documents. The schema may define parent-child relationships among fields, indicate which sections may be repeated or nested, and provide instructions or templates for parsing complex layouts. For example, the schema may specify that the Line Items section is an array of objects, each of which must include an Amount, Description, and Quantity, with optional fields for discounts or taxes.

The system may be further configured to handle variations in field naming, placement, or formatting by using alias lists, flexible matching, or learned associations. In some cases, the system may automatically adapt to new invoice templates by learning from user feedback, schema updates, or ground truth data. Nested and tabular fields may be output in various machine-readable formats, such as JSON arrays, XML elements, or database tables, to enable integration with downstream business processes or analytics platforms.

Although FIG. 9 is described with reference to an invoice, the principles and techniques for handling nested, grouped, or tabular structures may be applied to any document type with similar characteristics, including purchase orders, statements of work, medical records, insurance claims, or customs forms. The specific arrangement, labeling, and extraction logic for such structures may be modified, extended, or combined in different embodiments to meet the requirements of varied document types, industry standards, or user preferences. The system may be further configured to handle documents with missing, extra, or reordered fields, and may employ iterative extraction, validation, or feedback mechanisms to improve accuracy and robustness.

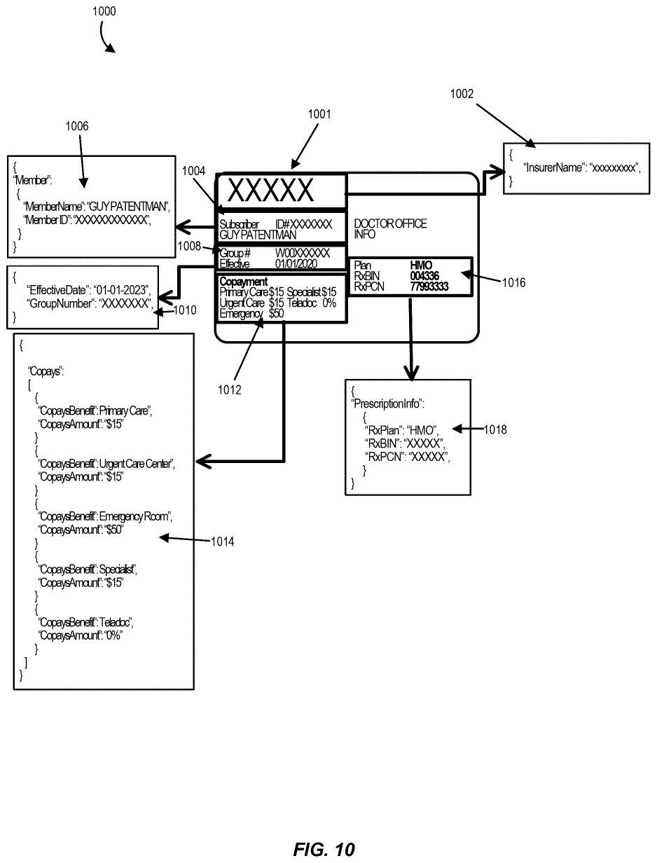

FIG. 10 may illustrate, in accordance with various embodiments, an example of a health insurance card 1000 and the associated process of spatially mapping and extracting structured information from different regions of the card. The figure is intended to demonstrate how a document understanding system may identify, segment, and interpret distinct spatial regions on a physical or digital health insurance card, and may generate corresponding structured data outputs in accordance with a defined schema.

In some embodiments, health insurance card 1000 may be provided as a scanned image, photograph, digital file, or any other visual or digital representation of a member's health insurance identification card. The arrangement, labeling, and content of health insurance card 1000 may vary according to insurer, issuing authority, card design, or regulatory requirements. Embodiments may be configured to process cards with diverse layouts, fonts, field names, or graphical elements.

A first spatial region 1001 may be identified on the card, which may correspond to a printed or displayed area containing the insurer's name, logo, or branding. The extraction system may be configured to recognize this region using image segmentation, spatial analysis, template matching, or machine learning models trained to identify common insurer branding locations. The associated extraction 1002 may be a structured output such as:

{
“InsurerName”: “xxxxxxxxx”,
}

In this example, the system may extract the name of the insurance provider as the value for the “InsurerName” field, but additional or alternative fields may be present depending on card design. The value may be obtained from printed text, logo interpretation, or both, and the system may be configured to handle variations in naming, abbreviations, or graphical presentation.

A second spatial region 1004 may correspond to a section of the card containing member information. This may include the member's name, member ID, or related identifiers, which may be grouped together or distributed across the card. The associated extraction 1006 may be a structured output such as:

```
{
  “Member”: {
    “MemberName”: “GUY PATENTMAN”,
    “Member ID”: “XXXXXXXXXXXX”
  }
}
```

In various embodiments, the system may be configured to aggregate related fields into a nested structure, such as a “Member” object, and may recognize member names, IDs, or other identifiers using spatial proximity, label detection, or learned associations. The specific fields included may be tailored to the schema, and the system may support flexible mapping for cards that use alternative field names, abbreviations, or formats.

A third spatial region 1008 may correspond to a portion of the card displaying plan details, such as the effective date of coverage and the group number. The associated extraction 1010 may be a structured output such as:

```
{
  “EffectiveDate”: “01-01-2023”,
  “GroupNumber”: “XXXXXXX”
}
```

The system may be configured to recognize date fields, numeric identifiers, and other plan attributes, and may map them to the appropriate schema fields based on label detection, positional conventions, or template matching. In some embodiments, additional plan details such as plan type, tier, or network may be present and extracted in a similar manner.

A fourth spatial region 1012 may include a table, grid, or textual listing of copayment information for various benefits, such as primary care, specialist visits, urgent care, telemedicine, or emergency services. The associated extraction 1014 may be a structured array such as:

```
{
  “Copays”: [
    {
      “CopaysBenefit”: “Primary Care”,
      “CopaysAmount”: “$15”
    },
    {
      “CopaysBenefit”: “Urgent Care Center”,
      “CopaysAmount”: “$15”
    },
    {
      “CopaysBenefit”: “Emergency Room”,
      “CopaysAmount”: “$50”
    },
    {
      “CopaysBenefit”: “Specialist”,
      “CopaysAmount”: “$15”
    },
    {
      “CopaysBenefit”: “Teladoc”,
      “CopaysAmount”: “0%”
    }
  ]
}
```

In some embodiments, the system may be configured to detect tabular, list, or grid layouts, parse multiple rows or columns, and map each row to an object in an array. Field names and values may be recognized using both spatial cues and label associations. The system may further support variations in copayment benefit naming, amount formatting (e.g., “$15,” “15 USD,” “0%”), or the inclusion of additional or fewer benefits.

A fifth spatial region 1016 may correspond to a section displaying prescription or pharmacy plan information, which may include fields such as plan type, RxBIN, and RxPCN numbers. The associated extraction 1018 may be a structured output such as:

```
{
  “PrescriptionInfo”: {
    “RxPlan”: “HMO”,
    “RxBIN”: “XXXXX”,
    “RxPCN”: “XXXXX”
  }
}
```

In some embodiments, the system may group prescription-related fields into a nested structure, and may recognize fields using label detection, font analysis, or learned spatial relationships. The system may accommodate variations in the presence, naming, or format of prescription plan attributes, and may support the extraction of additional fields such as RxGRP, RxID, or pharmacy network identifiers.

The described process may be enabled by a schema that defines the expected fields, data types, required or optional status, and nesting for each category of information present on the health insurance card. The schema may support aliasing for field names, default values for missing data, and validation or normalization rules for field values. In some embodiments, the schema may be dynamically selected or adapted based on card design, issuing authority, or user configuration.

The mapping of spatial regions (such as 1001, 1004, 1008, 1012, and 1016) to structured outputs (such as 1002, 1006, 1010, 1014, and 1018) may be accomplished using a combination of image segmentation, text detection, optical character recognition (OCR), spatial reasoning, and schema-driven prompting or extraction. The system may be configured to process single or multi-page cards, cards with mixed content types, or cards with irregular layouts or missing fields. Additional spatial regions and associated extractions may be supported as needed for other card designs or document types.

Although FIG. 10 is described with reference to a health insurance card, the techniques for mapping spatial regions to structured schema fields may be applied to other identification documents, benefit cards, membership cards, or any document, whether described herein or not, where information is grouped by location or context. The arrangement, grouping, and labeling of regions and fields may be modified, extended, or combined in different embodiments to support a wide range of document formats, industry standards, or user requirements.

It should be understood that the number, size, and placement of spatial regions and the structure of the extracted output are illustrative and not limiting. Embodiments may support arbitrary partitioning of the document into regions, dynamic or adaptive mapping of regions to schema fields, and iterative refinement or validation of extracted data. The system may further employ feedback, confidence scoring, or user correction to improve extraction accuracy and schema alignment over time.

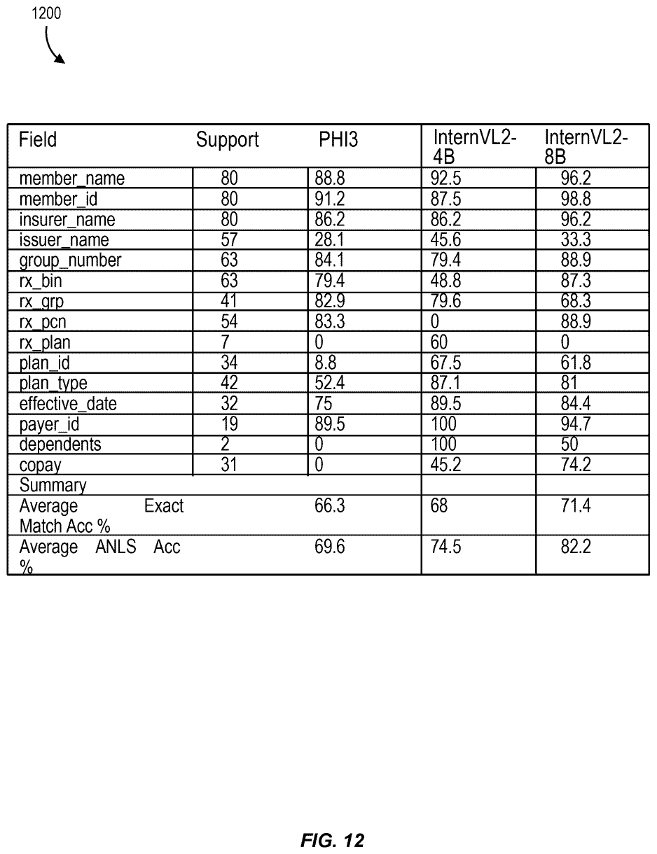

FIGS. 11 and 12 may illustrate, in accordance with various embodiments, comparative evaluation results for different approaches to key information extraction from structured documents, such as driving licenses and health or insurance cards. These figures are intended to demonstrate the system's ability to improve extraction accuracy and reliability when employing a schema-tuned large multimodal model (LMM) as compared to a base LMM configuration. The evaluation results depicted may be based on experiments performed using annotated datasets, and the data and metrics shown are illustrative and may be adapted for other fields, document types, or evaluation methodologies in different embodiments.

In FIG. 11, the evaluation focused on the extraction of specific fields from driving license documents. The figure presents comparative results for multiple extraction approaches, such as a base LMM (i.e., an LMM without schema guidance) and an LMM that is tuned or prompted using a schema as described in earlier sections. The evaluation included both exact match accuracy and Average Normalized Levenshtein Similarity (ANLS) as metrics for assessing extraction performance. ANLS may be used to account for near-matches or minor textual variations that are common in real-world document imaging and OCR tasks.

For example, FIG. 11 showed the following results for various fields:
For the “countryregion” field, the base LMM may achieve an accuracy of 43.3%, while the schema-tuned LMM may achieve 54.4%. The corresponding ANLS scores may be 43.3% for base LMM and 55.6% for schema-tuned LMM.
For the “region” field, base LMM may achieve 74.6% accuracy, schema-tuned LMM 83.6%, with ANLS scores of 86.1% and 86.9%, respectively.
For “documentnumber,” base LMM may achieve 71.1% accuracy, schema-tuned LMM 74.4%, with ANLS scores of 94.2% and 98.3%.
For “documentdiscriminator,” base LMM may have 0% accuracy, while schema-tuned LMM may achieve 13.6%, and ANLS may improve from 0% to 55.6%.
For fields such as “name,” “address,” “dateofbirth,” “dateofexpiration,” “dateofissue,” “haircolor,” “height,” “weight,” “sex,” “endorsements,” “restrictions,” and “vehicleclassifications,” similar improvements may be observed, with schema-tuned LMMs outperforming base LMMs in most metrics.

The summary statistics in FIG. 11 indicated that the base LMM achieves an overall accuracy of approximately 71.7%, while the schema-tuned LMM achieves 79.6%. For ANLS, the base LMM achieved 74.3% and the schema-tuned LMM achieved 83.2%. These results demonstrate that augmenting LMMs with schema-driven prompts or constraints can yield substantial improvements in both exact field extraction and tolerance to minor extraction errors, especially on fields that are ambiguous, variably formatted, or inconsistently labeled.

In FIG. 12, a similar evaluation may be presented for health or insurance card documents. Although the specific field-level results for health cards are described in writing, the figure illustrates analogous improvements in extraction performance when schema-tuned LMMs are used in this domain as well. For example, fields such as insurer name, member name, member ID, group number, effective date, plan type, copay amounts, and prescription information may all benefit from schema-driven extraction logic, especially in cases where field labels, positions, or formats vary significantly across issuers or card designs. The results show that schema tuning improves both the accuracy of field recognition and the consistency of extracted values, as measured by exact match and ANLS or other relevant metrics.

In some embodiments, the evaluation results illustrated in FIGS. 11 and 12 were obtained using internally and externally annotated datasets that are representative of real-world documents, with ground truth values established through expert review or multi-round annotation processes.

The comparative data in FIGS. 11 and 12 provides evidence for the utility of schema-driven extraction, as described in earlier figures and sections. By supplying LMMs with explicit schema constraints-such as field names, data types, required or default status, and aliases-systems may achieve more reliable, interpretable, and extensible extraction results across a wide variety of document types, formats, and data quality scenarios.

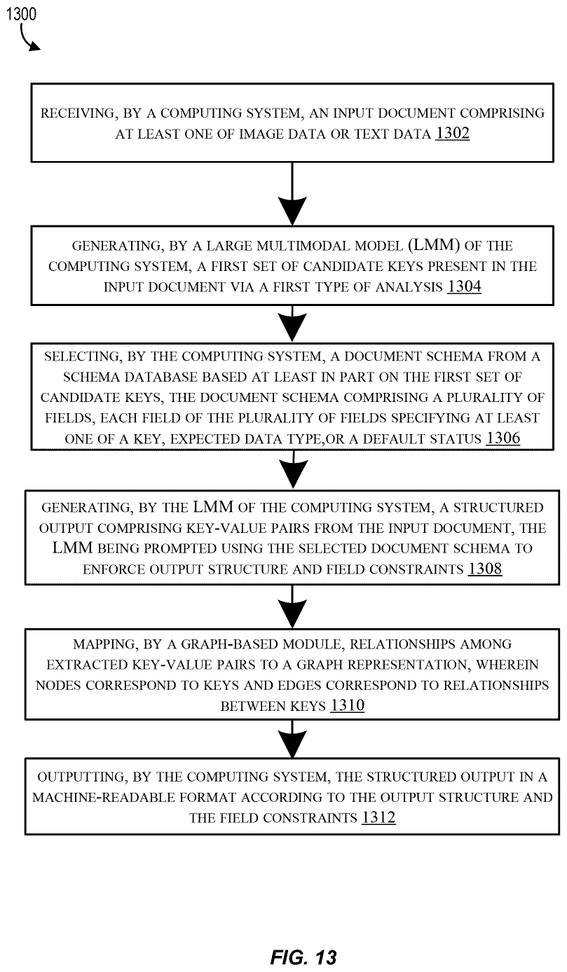

FIG. 13 may illustrate, in accordance with various embodiments, a flowchart of a method for extracting structured key information from a document using a large multimodal model (LMM) and a schema-driven framework. The steps depicted in FIG. 13 may be performed by a computing system comprising one or more processors, memory, and associated components, as described elsewhere in this disclosure. The order and grouping of steps shown in the flowchart are illustrative and may be modified, reordered, combined, or subdivided in alternative embodiments.

At step 1302, the method may include receiving, by a computing system, an input document comprising at least one of image data and text data. The input document may be received via any suitable interface or data source, such as a file upload, an API call, an email attachment, a document scanner, or a data stream from an external system. Image data may include, but is not limited to, raster images (e.g., JPEG, PNG, TIFF, BMP, GIF, HEIC), vector graphics (e.g., SVG), or image-embedded files (e.g., PDF). Text data may be provided as plain text, formatted text, or as part of a structured or semi-structured file. The input document may be a single page, a multi-page file, or a batch of documents, and may be provided in color, grayscale, or black-and-white formats. In some embodiments, pre-processing or normalization may be performed on the input document prior to further analysis.

At step 1304, the method may include generating, by a LMM and without prior training on the specific document type, a first set of candidate keys present in the input document via a first type of analysis. In many embodiments, this first type of analysis may be zero-shot analysis. Zero-shot analysis may refer to a process by which a system, such as a large multimodal model, can identify, interpret, or extract information from an input document without requiring prior training, fine-tuning, or explicit exposure to that specific document type, layout, or format. In some embodiments, zero-shot analysis may be achieved by prompting the model with general instructions, schema definitions, or contextual cues, allowing the system to generalize from its existing knowledge or learned representations to novel documents. For example, a system may be configured to extract fields from a newly encountered type of invoice by simply providing the document image and a prompt such as “Identify all key fields present in this document,” even if the system has never processed that particular invoice template before. In another example, a zero-shot approach may enable the extraction of a “Date of Birth” field from a driver's license issued in an unfamiliar format by leveraging the model's general understanding of common field names, abbreviations, and spatial conventions, without relying on pre-defined templates or training data for that specific license design. Zero-shot analysis may support a wide range of document types and languages, enabling flexible and scalable information extraction in diverse and dynamic real-world scenarios. The LMM may be any large multimodal model capable of processing visual and textual information, such as transformer-based vision-language models or other architectures suitable for interpreting document images and associated prompts. Zero-shot analysis may refer to the ability of the LMM to identify fields, entities, or key-value pairs in the document without having been explicitly trained or fine-tuned on the specific layout, format, or type of the document at hand. The set of candidate keys may include, but is not limited to, directly inferred fields, which can be identified by the presence of explicit labels, tags, or distinguishing features in the document, as well as latent fields, which may be inferred from contextual cues, spatial arrangement, font characteristics, world knowledge, statistical or machine learning models, or learned associations from prior data. In some embodiments, the set of candidate keys may further include derived or computed fields, which can be generated by applying logical operations, transformations, or domain-specific rules to one or more other extracted fields. The candidate keys may be represented in any suitable data structure, such as a list, table, graph, or hierarchical object, and may be annotated with additional metadata, such as positional information, extraction confidence, or candidate field type. In certain embodiments, the set of candidate keys may be supplemented, filtered, or prioritized based on schema information, external knowledge bases, or user input.

At step 1306, the method may include selecting a document schema from a schema database based on the first set of candidate keys, where the schema comprises a plurality of fields, each field specifying a key, expected data type, required or default status, and optional aliases. A document schema may refer to a structured collection of definitions that can specify the expected organization, field names, data types, required or optional status, default values, and aliases for information to be extracted from a given type of document. In some embodiments, a document schema may be represented as a data object-such as a JSON, XML, or database record-that can define, for each field, attributes including the canonical key, data type (for example, string, integer, or date), whether the field is required or optional, a default value, a description, and one or more aliases or alternative names. For example, a document schema for a driver's license may define fields such as “Name,” “Date of Birth,” “Address,” and “License Number,” where each field may include data type constraints, indicate if the field is mandatory, specify a default value such as “NA,” and list aliases such as “DOB” for “Date of Birth.” The schema database may contain schema definitions for a range of document types, formats, or use cases, and may be implemented as a local or remote repository, a distributed database, or an in-memory data structure. The selection process may involve matching the candidate keys to known schemas, dynamically generating or adapting a schema, or applying heuristic or learned rules to select the most appropriate schema for the document. Fields within the schema may be defined with flexibility to accommodate variations in labeling, order, or presence, and may include metadata such as data type (e.g., string, integer, date, enum), required status (e.g., mandatory, optional), default values (used when a field is missing), and aliases (alternative names or abbreviations for the field).

At step 1308, the method may include generating, by the LMM, a structured output comprising key-value pairs from the input document, wherein the LMM is prompted using the selected schema to enforce output structure and field constraints. The structured output may take the form of a flat list, a nested object, a table, or any other structured data representation, such as JSON, XML, YAML, or CSV. The LMM may be guided by the schema to extract only the fields specified, to enforce data type and format constraints, to recognize aliases, and to apply default values as needed. The LMM may use the schema to resolve ambiguities, disambiguate similar fields, and map extracted values to their canonical field names in the output structure. In some embodiments, the prompting process may involve providing the schema as a textual prompt, a structured template, or a combination thereof.

At step 1310, the method may include mapping, by a graph-based module, relationships among extracted key-value pairs to a graph representation, wherein nodes correspond to keys and edges correspond to relationships between keys. The graph-based module may construct a graph G=(V, E), where V is the set of nodes representing extracted fields or entities, and E is the set of edges representing spatial, logical, or semantic relationships between fields. Edges may encode relationships such as proximity, grouping, hierarchy, or association, and may be weighted or annotated with additional metadata. The graph representation may be used to further structure the output, to resolve complex or ambiguous extraction cases, or to enable downstream processing such as validation, reasoning, or knowledge graph integration. In some embodiments, the system may identify a subgraph G′ that maximizes a utility function over the nodes and edges, as described elsewhere in the disclosure.

At step 1312, the method may include outputting the structured output in a machine-readable format. The output may be provided to downstream systems, stored in a database, displayed to users, or transmitted over a network, and may be formatted as JSON, XML, YAML, CSV, or any other suitable data representation. In some embodiments, the output may include additional metadata, such as extraction confidence scores, provenance information, or references to the original document image or schema. The system may support integration with business workflows, analytics platforms, document management systems, or other applications that consume structured data.

### Example Architectures For Providing Cloud Services

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

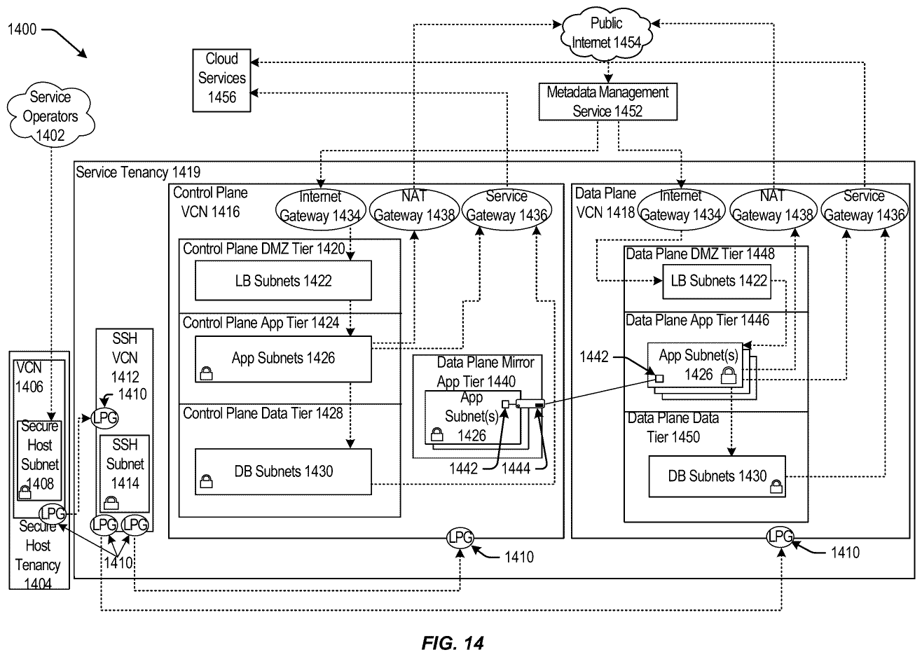

FIG. 14 is a block diagram 1400 illustrating an example pattern of an IaaS architecture, according to at least one embodiment. Service operators 1402 can be communicatively coupled to a secure host tenancy 1404 that can include a virtual cloud network (VCN) 1406 and a secure host subnet 1408. In some examples, the service operators 1402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1406 and/or the Internet.

The VCN 1406 can include a local peering gateway (LPG) 1410 that can be communicatively coupled to a secure shell (SSH) VCN 1412 via an LPG 1410 contained in the SSH VCN 1412. The SSH VCN 1412 can include an SSH subnet 1414, and the SSH VCN 1412 can be communicatively coupled to a control plane VCN 1416 via the LPG 1410 contained in the control plane VCN 1416. Also, the SSH VCN 1412 can be communicatively coupled to a data plane VCN 1418 via an LPG 1410. The control plane VCN 1416 and the data plane VCN 1418 can be contained in a service tenancy 1419 that can be owned and/or operated by the IaaS provider.

The control plane VCN 1416 can include a control plane demilitarized zone (DMZ) tier 1420 that acts as a perimeter network (e.g., portions of a corporate network between the corporate intranet and external networks). The DMZ-based servers may have restricted responsibilities and help keep breaches contained. Additionally, the DMZ tier 1420 can include one or more load balancer (LB) subnet(s) 1422, a control plane app tier 1424 that can include app subnet(s) 1426, a control plane data tier 1428 that can include database (DB) subnet(s) 1430 (e.g., frontend DB subnet(s) and/or backend DB subnet(s)). The LB subnet(s) 1422 contained in the control plane DMZ tier 1420 can be communicatively coupled to the app subnet(s) 1426 contained in the control plane app tier 1424 and an Internet gateway 1434 that can be contained in the control plane VCN 1416, and the app subnet(s) 1426 can be communicatively coupled to the DB subnet(s) 1430 contained in the control plane data tier 1428 and a service gateway 1436 and a network address translation (NAT) gateway 1438. The control plane VCN 1416 can include the service gateway 1436 and the NAT gateway 1438.

The control plane VCN 1416 can include a data plane mirror app tier 1440 that can include app subnet(s) 1426. The app subnet(s) 1426 contained in the data plane mirror app tier 1440 can include a virtual network interface controller (VNIC) 1442 that can execute a compute instance 1444. The compute instance 1444 can communicatively couple the app subnet(s) 1426 of the data plane mirror app tier 1440 to app subnet(s) 1426 that can be contained in a data plane app tier 1446.

The data plane VCN 1418 can include the data plane app tier 1446, a data plane DMZ tier 1448, and a data plane data tier 1450. The data plane DMZ tier 1448 can include LB subnet(s) 1422 that can be communicatively coupled to the app subnet(s) 1426 of the data plane app tier 1446 and the Internet gateway 1434 of the data plane VCN 1418. The app subnet(s) 1426 can be communicatively coupled to the service gateway 1436 of the data plane VCN 1418 and the NAT gateway 1438 of the data plane VCN 1418. The data plane data tier 1450 can also include the DB subnet(s) 1430 that can be communicatively coupled to the app subnet(s) 1426 of the data plane app tier 1446.

The Internet gateway 1434 of the control plane VCN 1416 and of the data plane VCN 1418 can be communicatively coupled to a metadata management service 1452 that can be communicatively coupled to public Internet 1454. Public Internet 1454 can be communicatively coupled to the NAT gateway 1438 of the control plane VCN 1416 and of the data plane VCN 1418. The service gateway 1436 of the control plane VCN 1416 and of the data plane VCN 1418 can be communicatively couple to cloud services 1456.

In some examples, the service gateway 1436 of the control plane VCN 1416 or of the data plane VCN 1418 can make application programming interface (API) calls to cloud services 1456 without going through public Internet 1454. The API calls to cloud services 1456 from the service gateway 1436 can be one-way: the service gateway 1436 can make API calls to cloud services 1456, and cloud services 1456 can send requested data to the service gateway 1436. But, cloud services 1456 may not initiate API calls to the service gateway 1436.

In some examples, the secure host tenancy 1404 can be directly connected to the service tenancy 1419, which may be otherwise isolated. The secure host subnet 1408 can communicate with the SSH subnet 1414 through an LPG 1410 that may enable two-way communication over an otherwise isolated system. Connecting the secure host subnet 1408 to the SSH subnet 1414 may give the secure host subnet 1408 access to other entities within the service tenancy 1419.

The control plane VCN 1416 may allow users of the service tenancy 1419 to set up or otherwise provision desired resources. Desired resources provisioned in the control plane VCN 1416 may be deployed or otherwise used in the data plane VCN 1418. In some examples, the control plane VCN 1416 can be isolated from the data plane VCN 1418, and the data plane mirror app tier 1440 of the control plane VCN 1416 can communicate with the data plane app tier 1446 of the data plane VCN 1418 via VNICs 1442 that can be contained in the data plane mirror app tier 1440 and the data plane app tier 1446.

In some examples, users of the system, or customers, can make requests, for example create, read, update, or delete (CRUD) operations, through public Internet 1454 that can communicate the requests to the metadata management service 1452. The metadata management service 1452 can communicate the request to the control plane VCN 1416 through the Internet gateway 1434. The request can be received by the LB subnet(s) 1422 contained in the control plane DMZ tier 1420. The LB subnet(s) 1422 may determine that the request is valid, and in response to this determination, the LB subnet(s) 1422 can transmit the request to app subnet(s) 1426 contained in the control plane app tier 1424. If the request is validated and requires a call to public Internet 1454, the call to public Internet 1454 may be transmitted to the NAT gateway 1438 that can make the call to public Internet 1454. Metadata that may be desired to be stored by the request can be stored in the DB subnet(s) 1430.

In some examples, the data plane mirror app tier 1440 can facilitate direct communication between the control plane VCN 1416 and the data plane VCN 1418. For example, changes, updates, or other suitable modifications to configuration may be desired to be applied to the resources contained in the data plane VCN 1418. Via a VNIC 1442, the control plane VCN 1416 can directly communicate with, and can thereby execute the changes, updates, or other suitable modifications to configuration to, resources contained in the data plane VCN 1418.

In some embodiments, the control plane VCN 1416 and the data plane VCN 1418 can be contained in the service tenancy 1419. In this case, the user, or the customer, of the system may not own or operate either the control plane VCN 1416 or the data plane VCN 1418. Instead, the IaaS provider may own or operate the control plane VCN 1416 and the data plane VCN 1418, both of which may be contained in the service tenancy 1419. This embodiment can enable isolation of networks that may prevent users or customers from interacting with other users', or other customers', resources. Also, this embodiment may allow users or customers of the system to store databases privately without needing to rely on public Internet 1454, which may not have a desired level of threat prevention, for storage.

In other embodiments, the LB subnet(s) 1422 contained in the control plane VCN 1416 can be configured to receive a signal from the service gateway 1436. In this embodiment, the control plane VCN 1416 and the data plane VCN 1418 may be configured to be called by a customer of the IaaS provider without calling public Internet 1454. Customers of the IaaS provider may desire this embodiment since database(s) that the customers use may be controlled by the IaaS provider and may be stored on the service tenancy 1419, which may be isolated from public Internet 1454.

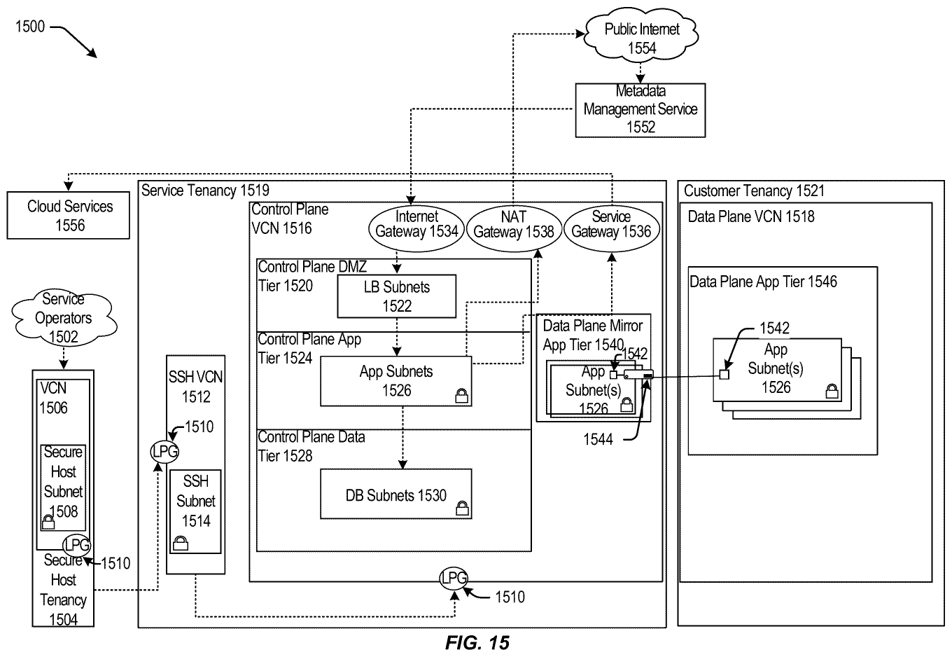

FIG. 15 is a block diagram 1500 illustrating another example pattern of an IaaS architecture, according to at least one embodiment. Service operators 1502 (e.g., service operators 1402 of FIG. 14) can be communicatively coupled to a secure host tenancy 1504 (e.g., the secure host tenancy 1404 of FIG. 14) that can include a virtual cloud network (VCN) 1506 (e.g., the VCN 1406 of FIG. 14) and a secure host subnet 1508 (e.g., the secure host subnet 1408 of FIG. 14). The VCN 1506 can include a local peering gateway (LPG) 1510 (e.g., the LPG 1410 of FIG. 14) that can be communicatively coupled to a secure shell (SSH) VCN 1512 (e.g., the SSH VCN 1412 of FIG. 14) via an LPG 1410 contained in the SSH VCN 1512. The SSH VCN 1512 can include an SSH subnet 1514 (e.g., the SSH subnet 1414 of FIG. 14), and the SSH VCN 1512 can be communicatively coupled to a control plane VCN 1516 (e.g., the control plane VCN 1416 of FIG. 14) via an LPG 1510 contained in the control plane VCN 1516. The control plane VCN 1516 can be contained in a service tenancy 1519 (e.g., the service tenancy 1419 of FIG. 14), and the data plane VCN 1518 (e.g., the data plane VCN 1418 of FIG. 14) can be contained in a customer tenancy 1521 that may be owned or operated by users, or customers, of the system.

The control plane VCN 1516 can include a control plane DMZ tier 1520 (e.g., the control plane DMZ tier 1420 of FIG. 14) that can include LB subnet(s) 1522 (e.g., LB subnet(s) 1422 of FIG. 14), a control plane app tier 1524 (e.g., the control plane app tier 1424 of FIG. 14) that can include app subnet(s) 1526 (e.g., app subnet(s) 1426 of FIG. 14), a control plane data tier 1528 (e.g., the control plane data tier 1428 of FIG. 14) that can include database (DB) subnet(s) 1530 (e.g., similar to DB subnet(s) 1430 of FIG. 14). The LB subnet(s) 1522 contained in the control plane DMZ tier 1520 can be communicatively coupled to the app subnet(s) 1526 contained in the control plane app tier 1524 and an Internet gateway 1534 (e.g., the Internet gateway 1434 of FIG. 14) that can be contained in the control plane VCN 1516, and the app subnet(s) 1526 can be communicatively coupled to the DB subnet(s) 1530 contained in the control plane data tier 1528 and a service gateway 1536 (e.g., the service gateway 1436 of FIG. 14) and a network address translation (NAT) gateway 1538 (e.g., the NAT gateway 1438 of FIG. 14). The control plane VCN 1516 can include the service gateway 1536 and the NAT gateway 1538.

The control plane VCN 1516 can include a data plane mirror app tier 1540 (e.g., the data plane mirror app tier 1440 of FIG. 14) that can include app subnet(s) 1526. The app subnet(s) 1526 contained in the data plane mirror app tier 1540 can include a virtual network interface controller (VNIC) 1542 (e.g., the VNIC of 1442) that can execute a compute instance 1544 (e.g., similar to the compute instance 1444 of FIG. 14). The compute instance 1544 can facilitate communication between the app subnet(s) 1526 of the data plane mirror app tier 1540 and the app subnet(s) 1526 that can be contained in a data plane app tier 1546 (e.g., the data plane app tier 1446 of FIG. 14) via the VNIC 1542 contained in the data plane mirror app tier 1540 and the VNIC 1542 contained in the data plane app tier 1546.

The Internet gateway 1534 contained in the control plane VCN 1516 can be communicatively coupled to a metadata management service 1552 (e.g., the metadata management service 1452 of FIG. 14) that can be communicatively coupled to public Internet 1554 (e.g., public Internet 1454 of FIG. 14). Public Internet 1554 can be communicatively coupled to the NAT gateway 1538 contained in the control plane VCN 1516. The service gateway 1536 contained in the control plane VCN 1516 can be communicatively couple to cloud services 1556 (e.g., cloud services 1456 of FIG. 14).

In some examples, the data plane VCN 1518 can be contained in the customer tenancy 1521. In this case, the IaaS provider may provide the control plane VCN 1516 for each customer, and the IaaS provider may, for each customer, set up a unique compute instance 1544 that is contained in the service tenancy 1519. Each compute instance 1544 may allow communication between the control plane VCN 1516, contained in the service tenancy 1519, and the data plane VCN 1518 that is contained in the customer tenancy 1521. The compute instance 1544 may allow resources, that are provisioned in the control plane VCN 1516 that is contained in the service tenancy 1519, to be deployed or otherwise used in the data plane VCN 1518 that is contained in the customer tenancy 1521.

In other examples, the customer of the IaaS provider may have databases that live in the customer tenancy 1521. In this example, the control plane VCN 1516 can include the data plane mirror app tier 1540 that can include app subnet(s) 1526. The data plane mirror app tier 1540 can reside in the data plane VCN 1518, but the data plane mirror app tier 1540 may not live in the data plane VCN 1518. That is, the data plane mirror app tier 1540 may have access to the customer tenancy 1521, but the data plane mirror app tier 1540 may not exist in the data plane VCN 1518 or be owned or operated by the customer of the IaaS provider. The data plane mirror app tier 1540 may be configured to make calls to the data plane VCN 1518 but may not be configured to make calls to any entity contained in the control plane VCN 1516. The customer may desire to deploy or otherwise use resources in the data plane VCN 1518 that are provisioned in the control plane VCN 1516, and the data plane mirror app tier 1540 can facilitate the desired deployment, or other usage of resources, of the customer.

In some embodiments, the customer of the IaaS provider can apply filters to the data plane VCN 1518. In this embodiment, the customer can determine what the data plane VCN 1518 can access, and the customer may restrict access to public Internet 1554 from the data plane VCN 1518. The IaaS provider may not be able to apply filters or otherwise control access of the data plane VCN 1518 to any outside networks or databases. Applying filters and controls by the customer onto the data plane VCN 1518, contained in the customer tenancy 1521, can help isolate the data plane VCN 1518 from other customers and from public Internet 1554.

In some embodiments, cloud services 1556 can be called by the service gateway 1536 to access services that may not exist on public Internet 1554, on the control plane VCN 1516, or on the data plane VCN 1518. The connection between cloud services 1556 and the control plane VCN 1516 or the data plane VCN 1518 may not be live or continuous. Cloud services 1556 may exist on a different network owned or operated by the IaaS provider. Cloud services 1556 may be configured to receive calls from the service gateway 1536 and may be configured to not receive calls from public Internet 1554. Some cloud services 1556 may be isolated from other cloud services 1556, and the control plane VCN 1516 may be isolated from cloud services 1556 that may not be in the same region as the control plane VCN 1516. For example, the control plane VCN 1516 may be located in “Region 1,” and cloud service “Deployment 14,” may be located in Region 1 and in “Region 2.” If a call to Deployment 14 is made by the service gateway 1536 contained in the control plane VCN 1516 located in Region 1, the call may be transmitted to Deployment 14 in Region 1. In this example, the control plane VCN 1516, or Deployment 14 in Region 1, may not be communicatively coupled to, or otherwise in communication with, Deployment 14 in Region 2.

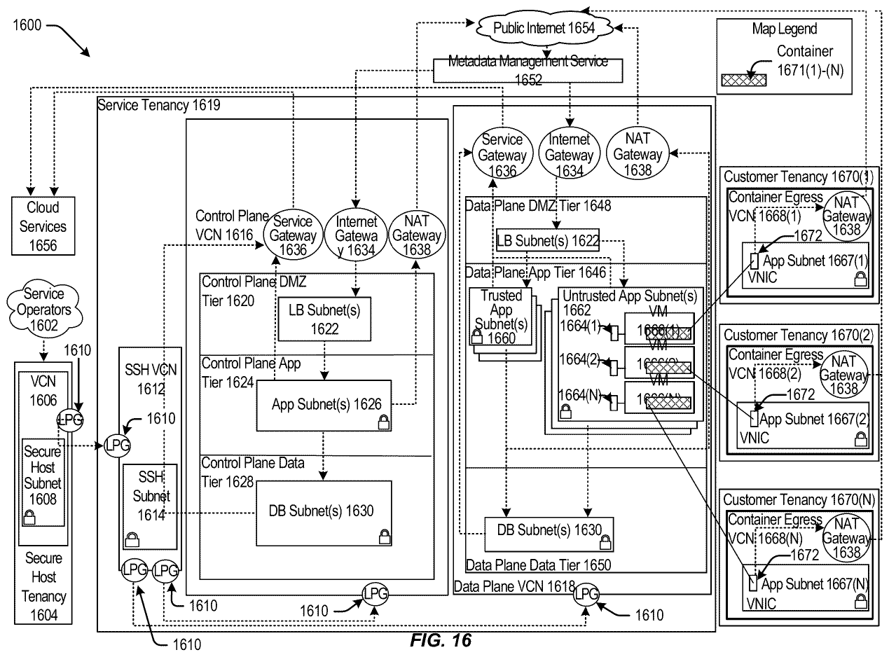

FIG. 16 is a block diagram 1600 illustrating another example pattern of an IaaS architecture, according to at least one embodiment. Service operators 1602 (e.g., service operators 1402 of FIG. 14) can be communicatively coupled to a secure host tenancy 1604 (e.g., the secure host tenancy 1404 of FIG. 14) that can include a virtual cloud network (VCN) 1606 (e.g., the VCN 1406 of FIG. 14) and a secure host subnet 1608 (e.g., the secure host subnet 1408 of FIG. 14). The VCN 1606 can include an LPG 1610 (e.g., the LPG 1410 of FIG. 14) that can be communicatively coupled to an SSH VCN 1612 (e.g., the SSH VCN 1412 of FIG. 14) via an LPG 1610 contained in the SSH VCN 1612. The SSH VCN 1612 can include an SSH subnet 1614 (e.g., the SSH subnet 1414 of FIG. 14), and the SSH VCN 1612 can be communicatively coupled to a control plane VCN 1616 (e.g., the control plane VCN 1416 of FIG. 14) via an LPG 1610 contained in the control plane VCN 1616 and to a data plane VCN 1618 (e.g., the data plane 1418 of FIG. 14) via an LPG 1610 contained in the data plane VCN 1618. The control plane VCN 1616 and the data plane VCN 1618 can be contained in a service tenancy 1619 (e.g., the service tenancy 1419 of FIG. 14).

The control plane VCN 1616 can include a control plane DMZ tier 1620 (e.g., the control plane DMZ tier 1420 of FIG. 14) that can include load balancer (LB) subnet(s) 1622 (e.g., LB subnet(s) 1422 of FIG. 14), a control plane app tier 1624 (e.g., the control plane app tier 1424 of FIG. 14) that can include app subnet(s) 1626 (e.g., similar to app subnet(s) 1426 of FIG. 14), a control plane data tier 1628 (e.g., the control plane data tier 1428 of FIG. 14) that can include DB subnet(s) 1630. The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1434 of FIG. 14) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 14) and a network address translation (NAT) gateway 1638 (e.g., the NAT gateway 1438 of FIG. 14). The control plane VCN 1616 can include the service gateway 1636 and the NAT gateway 1638.

The data plane VCN 1618 can include a data plane app tier 1646 (e.g., the data plane app tier 1446 of FIG. 14), a data plane DMZ tier 1648 (e.g., the data plane DMZ tier 1448 of FIG. 14), and a data plane data tier 1650 (e.g., the data plane data tier 1450 of FIG. 14). The data plane DMZ tier 1648 can include LB subnet(s) 1622 that can be communicatively coupled to trusted app subnet(s) 1660 and untrusted app subnet(s) 1662 of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include one or more primary VNICs 1664(1)-(N) that can be communicatively coupled to tenant virtual machines (VMs) 1666(1)-(N). Each tenant VM 1666(1)-(N) can be communicatively coupled to a respective app subnet 1667(1)-(N) that can be contained in respective container egress VCNs 1668(1)-(N) that can be contained in respective customer tenancies 1670(1)-(N). Respective secondary VNICs 1672(1)-(N) can facilitate communication between the untrusted app subnet(s) 1662 contained in the data plane VCN 1618 and the app subnet contained in the container egress VCNs 1668(1)-(N). Each container egress VCNs 1668(1)-(N) can include a NAT gateway 1638 that can be communicatively coupled to public Internet 1654 (e.g., public Internet 1454 of FIG. 14).

The Internet gateway 1634 contained in the control plane VCN 1616 and contained in the data plane VCN 1618 can be communicatively coupled to a metadata management service 1652 (e.g., the metadata management system 1452 of FIG. 14) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively couple to cloud services 1656.

In some embodiments, the data plane VCN 1618 can be integrated with customer tenancies 1670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1646. Code to run the function may be executed in the VMs 1666(1)-(N), and the code may not be configured to run anywhere else on the data plane VCN 1618. Each VM 1666(1)-(N) may be connected to one customer tenancy 1670. Respective containers 1671(1)-(N) contained in the VMs 1666(1)-(N) may be configured to run the code. In this case, there can be a dual isolation (e.g., the containers 1671(1)-(N) running code, where the containers 1671(1)-(N) may be contained in at least the VM 1666(1)-(N) that are contained in the untrusted app subnet(s) 1662), which may help prevent incorrect or otherwise undesirable code from damaging the network of the IaaS provider or from damaging a network of a different customer. The containers 1671(1)-(N) may be communicatively coupled to the customer tenancy 1670 and may be configured to transmit or receive data from the customer tenancy 1670. The containers 1671(1)-(N) may not be configured to transmit or receive data from any other entity in the data plane VCN 1618. Upon completion of running the code, the IaaS provider may kill or otherwise dispose of the containers 1671(1)-(N).

In some embodiments, the trusted app subnet(s) 1660 may run code that may be owned or operated by the IaaS provider. In this embodiment, the trusted app subnet(s) 1660 may be communicatively coupled to the DB subnet(s) 1630 and be configured to execute CRUD operations in the DB subnet(s) 1630. The untrusted app subnet(s) 1662 may be communicatively coupled to the DB subnet(s) 1630, but in this embodiment, the untrusted app subnet(s) may be configured to execute read operations in the DB subnet(s) 1630. The containers 1671(1)-(N) that can be contained in the VM 1666(1)-(N) of each customer and that may run code from the customer may not be communicatively coupled with the DB subnet(s) 1630.

In other embodiments, the control plane VCN 1616 and the data plane VCN 1618 may not be directly communicatively coupled. In this embodiment, there may be no direct communication between the control plane VCN 1616 and the data plane VCN 1618. However, communication can occur indirectly through at least one method. An LPG 1610 may be established by the IaaS provider that can facilitate communication between the control plane VCN 1616 and the data plane VCN 1618. In another example, the control plane VCN 1616 or the data plane VCN 1618 can make a call to cloud services 1656 via the service gateway 1636. For example, a call to cloud services 1656 from the control plane VCN 1616 can include a request for a service that can communicate with the data plane VCN 1618.

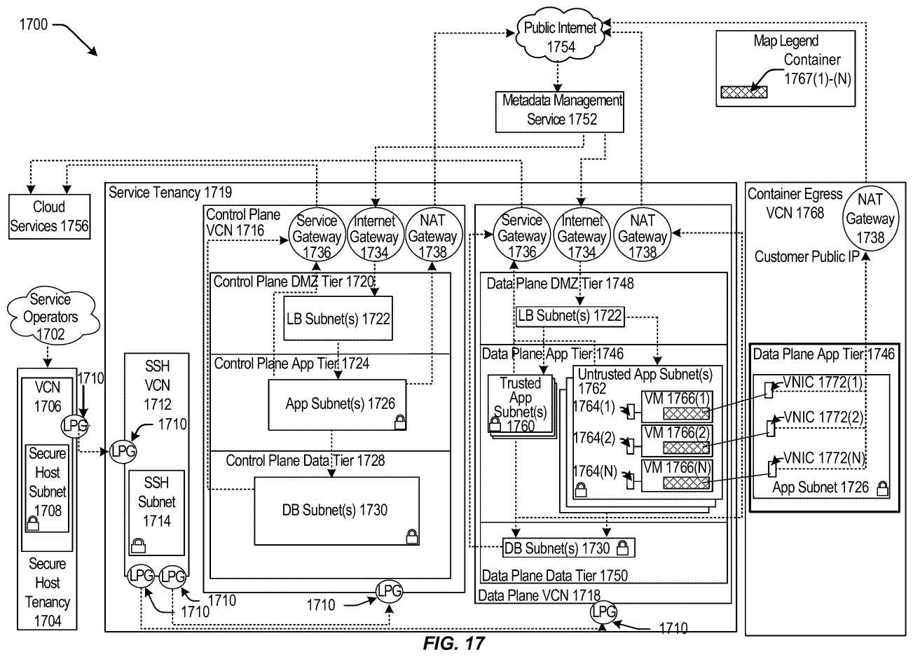

FIG. 17 is a block diagram 1700 illustrating another example pattern of an IaaS architecture, according to at least one embodiment. Service operators 1702 (e.g., service operators 1402 of FIG. 14) can be communicatively coupled to a secure host tenancy 1704 (e.g., the secure host tenancy 1404 of FIG. 14) that can include a virtual cloud network (VCN) 1706 (e.g., the VCN 1406 of FIG. 14) and a secure host subnet 1708 (e.g., the secure host subnet 1408 of FIG. 14). The VCN 1706 can include an LPG 1710 (e.g., the LPG 1410 of FIG. 14) that can be communicatively coupled to an SSH VCN 1712 (e.g., the SSH VCN 1412 of FIG. 14) via an LPG 1710 contained in the SSH VCN 1712. The SSH VCN 1712 can include an SSH subnet 1714 (e.g., the SSH subnet 1414 of FIG. 14), and the SSH VCN 1712 can be communicatively coupled to a control plane VCN 1716 (e.g., the control plane VCN 1416 of FIG. 14) via an LPG 1710 contained in the control plane VCN 1716 and to a data plane VCN 1718 (e.g., the data plane 1418 of FIG. 14) via an LPG 1710 contained in the data plane VCN 1718. The control plane VCN 1716 and the data plane VCN 1718 can be contained in a service tenancy 1719 (e.g., the service tenancy 1419 of FIG. 14).

The control plane VCN 1716 can include a control plane DMZ tier 1720 (e.g., the control plane DMZ tier 1420 of FIG. 14) that can include LB subnet(s) 1722 (e.g., LB subnet(s) 1422 of FIG. 14), a control plane app tier 1724 (e.g., the control plane app tier 1424 of FIG. 14) that can include app subnet(s) 1726 (e.g., app subnet(s) 1426 of FIG. 14), a control plane data tier 1728 (e.g., the control plane data tier 1428 of FIG. 14) that can include DB subnet(s) 1730 (e.g., DB subnet(s) 1630 of FIG. 16). The LB subnet(s) 1722 contained in the control plane DMZ tier 1720 can be communicatively coupled to the app subnet(s) 1726 contained in the control plane app tier 1724 and to an Internet gateway 1734 (e.g., the Internet gateway 1434 of FIG. 14) that can be contained in the control plane VCN 1716, and the app subnet(s) 1726 can be communicatively coupled to the DB subnet(s) 1730 contained in the control plane data tier 1728 and to a service gateway 1736 (e.g., the service gateway of FIG. 14) and a network address translation (NAT) gateway 1738 (e.g., the NAT gateway 1438 of FIG. 14). The control plane VCN 1716 can include the service gateway 1736 and the NAT gateway 1738.

The data plane VCN 1718 can include a data plane app tier 1746 (e.g., the data plane app tier 1446 of FIG. 14), a data plane DMZ tier 1748 (e.g., the data plane DMZ tier 1448 of FIG. 14), and a data plane data tier 1750 (e.g., the data plane data tier 1450 of FIG. 14). The data plane DMZ tier 1748 can include LB subnet(s) 1722 that can be communicatively coupled to trusted app subnet(s) 1760 (e.g., trusted app subnet(s) 1660 of FIG. 16) and untrusted app subnet(s) 1762 (e.g., untrusted app subnet(s) 1662 of FIG. 16) of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include primary VNICs 1764(1)-(N) that can be communicatively coupled to tenant virtual machines (VMs) 1766(1)-(N) residing within the untrusted app subnet(s) 1762. Each tenant VM 1766(1)-(N) can run code in a respective container 1767(1)-(N), and be communicatively coupled to an app subnet 1726 that can be contained in a data plane app tier 1746 that can be contained in a container egress VCN 1768. Respective secondary VNICs 1772(1)-(N) can facilitate communication between the untrusted app subnet(s) 1762 contained in the data plane VCN 1718 and the app subnet contained in the container egress VCN 1768. The container egress VCN can include a NAT gateway 1738 that can be communicatively coupled to public Internet 1754 (e.g., public Internet 1454 of FIG. 14).

The Internet gateway 1734 contained in the control plane VCN 1716 and contained in the data plane VCN 1718 can be communicatively coupled to a metadata management service 1752 (e.g., the metadata management system 1452 of FIG. 14) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively couple to cloud services 1756.

In some examples, the pattern illustrated by the architecture of block diagram 1700 of FIG. 17 may be considered an exception to the pattern illustrated by the architecture of block diagram 1600 of FIG. 16 and may be desirable for a customer of the IaaS provider if the IaaS provider cannot directly communicate with the customer (e.g., a disconnected region). The respective containers 1767(1)-(N) that are contained in the VMs 1766(1)-(N) for each customer can be accessed in real-time by the customer. The containers 1767(1)-(N) may be configured to make calls to respective secondary VNICs 1772(1)-(N) contained in app subnet(s) 1726 of the data plane app tier 1746 that can be contained in the container egress VCN 1768. The secondary VNICs 1772(1)-(N) can transmit the calls to the NAT gateway 1738 that may transmit the calls to public Internet 1754. In this example, the containers 1767(1)-(N) that can be accessed in real-time by the customer can be isolated from the control plane VCN 1716 and can be isolated from other entities contained in the data plane VCN 1718. The containers 1767(1)-(N) may also be isolated from resources from other customers.

In other examples, the customer can use the containers 1767(1)-(N) to call cloud services 1756. In this example, the customer may run code in the containers 1767(1)-(N) that requests a service from cloud services 1756. The containers 1767(1)-(N) can transmit this request to the secondary VNICs 1772(1)-(N) that can transmit the request to the NAT gateway that can transmit the request to public Internet 1754. Public Internet 1754 can transmit the request to LB subnet(s) 1722 contained in the control plane VCN 1716 via the Internet gateway 1734. In response to determining the request is valid, the LB subnet(s) can transmit the request to app subnet(s) 1726 that can transmit the request to cloud services 1756 via the service gateway 1736.

It should be appreciated that IaaS architectures 1400, 1500, 1600, 1700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

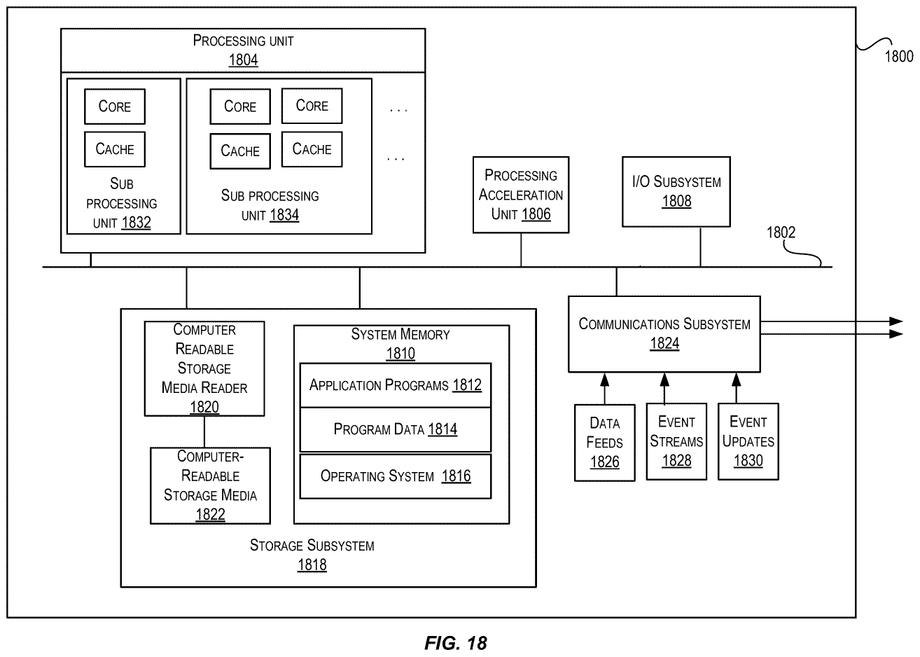

FIG. 18 illustrates an example computer system 1800, in which various embodiments may be implemented. The system 1800 may be used to implement any of the computer systems described above. As shown in the figure, computer system 1800 includes a processing unit 1804 that communicates with a number of peripheral subsystems via a bus subsystem 1802. These peripheral subsystems may include a processing acceleration unit 1806, an I/O subsystem 1808, a storage subsystem 1818 and a communications subsystem 1824. Storage subsystem 1818 includes tangible computer-readable storage media 1822 and a system memory 1810.

Bus subsystem 1802 provides a mechanism for letting the various components and subsystems of computer system 1800 communicate with each other as intended. Although bus subsystem 1802 is shown schematically as a single bus, alternative embodiments of the bus subsystem may utilize multiple buses. Bus subsystem 1802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1804, which can be implemented as one or more integrated circuits (e.g., a conventional microprocessor or microcontroller), controls the operation of computer system 1800. One or more processors may be included in processing unit 1804. These processors may include single core or multicore processors. In certain embodiments, processing unit 1804 may be implemented as one or more independent processing units 1832 and/or 1834 with single or multicore processors included in each processing unit. In other embodiments, processing unit 1804 may also be implemented as a quad-core processing unit formed by integrating two dual-core processors into a single chip.

In various embodiments, processing unit 1804 can execute a variety of programs in response to program code and can maintain multiple concurrently executing programs or processes. At any given time, some or all of the program code to be executed can be resident in processor(s) 1804 and/or in storage subsystem 1818. Through suitable programming, processor(s) 1804 can provide various functionalities described above. Computer system 1800 may additionally include a processing acceleration unit 1806, which can include a digital signal processor (DSP), a special-purpose processor, and/or the like.

I/O subsystem 1808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1800 may comprise a storage subsystem 1818 that comprises software elements, shown as being currently located within a system memory 1810. System memory 1810 may store program instructions that are loadable and executable on processing unit 1804, as well as data generated during the execution of these programs.

Depending on the configuration and type of computer system 1800, system memory 1810 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1804. In some implementations, system memory 1810 may include multiple different types of memory, such as static random access memory (SRAM) or dynamic random access memory (DRAM). In some implementations, a basic input/output system (BIOS), containing the basic routines that help to transfer information between elements within computer system 1800, such as during start-up, may typically be stored in the ROM. By way of example, and not limitation, system memory 1810 also illustrates application programs 1812, which may include client applications, Web browsers, mid-tier applications, relational database management systems (RDBMS), etc., program data 1814, and an operating system 1816. By way of example, operating system 1816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1818 may also provide a tangible computer-readable storage medium for storing the basic programming and data constructs that provide the functionality of some embodiments. Software (programs, code modules, instructions) that when executed by a processor provide the functionality described above may be stored in storage subsystem 1818. These software modules or instructions may be executed by processing unit 1804. Storage subsystem 1818 may also provide a repository for storing data used in accordance with the present disclosure.

Storage subsystem 1800 may also include a computer-readable storage media reader 1820 that can further be connected to computer-readable storage media 1822. Together and, optionally, in combination with system memory 1810, computer-readable storage media 1822 may comprehensively represent remote, local, fixed, and/or removable storage devices plus storage media for temporarily and/or more permanently containing, storing, transmitting, and retrieving computer-readable information.

Computer-readable storage media 1822 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1800.

By way of example, computer-readable storage media 1822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1822 may include, but is not limited to, Zip® drives, flash memory cards, universal serial bus (USB) flash drives, secure digital (SD) cards, DVD disks, digital video tape, and the like. Computer-readable storage media 1822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1800.

Communications subsystem 1824 provides an interface to other computer systems and networks. Communications subsystem 1824 serves as an interface for receiving data from and transmitting data to other systems from computer system 1800. For example, communications subsystem 1824 may enable computer system 1800 to connect to one or more devices via the Internet. In some embodiments communications subsystem 1824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1824 can provide wired network connectivity (e.g., Ethernet) in addition to or instead of a wireless interface.

In some embodiments, communications subsystem 1824 may also receive input communication in the form of structured and/or unstructured data feeds 1826, event streams 1828, event updates 1830, and the like on behalf of one or more users who may use computer system 1800.

By way of example, communications subsystem 1824 may be configured to receive data feeds 1826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1824 may also be configured to receive data in the form of continuous data streams, which may include event streams 1828 of real-time events and/or event updates 1830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1824 may also be configured to output the structured and/or unstructured data feeds 1826, event streams 1828, event updates 1830, and the like to one or more databases that may be in communication with one or more streaming data source computers coupled to computer system 1800.

Computer system 1800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

What is claimed is:

1. A method, comprising:
receiving, by a computing system, an input document comprising at least one of image data or text data;
generating, by a large multimodal model (LMM) of the computing system, a first set of candidate keys present in the input document via a first type of analysis;
selecting, by the computing system, a document schema from a schema database based at least in part on the first set of candidate keys, the document schema comprising a plurality of fields, each field of the plurality of fields specifying at least one of a key, expected data type, or a default status;
generating, by the LMM of the computing system, a structured output comprising key-value pairs from the input document, the LMM being prompted using the selected document schema to enforce output structure and field constraints; and
outputting, by the computing system, the structured output in a machine-readable format according to the output structure and the field constraints.

2. The method of claim 1, wherein the document schema further specifies explicit data types and default values for each field, and wherein absent fields in the input document are assigned the respective default values in the structured output.

3. The method of claim 1, wherein the document schema supports nested structures and tabular data, and wherein the step of generating the structured output further comprises extracting and hierarchically organizing nested or tabular information from the document.

4. The method of claim 1, further comprising, prior to outputting the structured output:
evaluating the structured output against ground truth data, and updating the document schema in the document schema database based on the evaluation if an accuracy metric falls below a predefined threshold.

5. The method of claim 1, wherein the LMM is prompted with specialized prompt templates tailored to the document type, the prompt templates being dynamically generated or adapted based on the selected document schema.

6. The method of claim 1, further comprising:
mapping, by a graph-based module, relationships among extracted key-value pairs to a graph representation, wherein nodes correspond to keys and edges correspond to relationships between keys; and
wherein the graph-based module identifies at least one subgraph comprising a subset of the extracted keys and relationships, the subgraph being selected to maximize a utility function defined over nodes and edges.

7. The method of claim 1, wherein the document schema includes alias definitions for at least one field, and wherein the LMM is configured to recognize and extract values corresponding to any of the aliases definitions associated with the field.

8. A system for extracting structured key information from a document, the system comprising:
at least one processor; and
a memory storing instructions that, when executed by the at least one processor, cause the system to:
receive, by a computing system, an input document comprising at least one of image data or text data;
generate, by a large multimodal model (LMM) of the computing system, a first set of candidate keys present in the input document via a first type of analysis;
select, by the computing system, a document schema from a schema database based at least in part on the first set of candidate keys, the document schema comprising a plurality of fields, each field of the plurality of fields specifying at least one of a key, expected data type, or a default status;
generate, by the LMM of the computing system, a structured output comprising key-value pairs from the input document, the LMM being prompted using the selected document schema to enforce output structure and field constraints; and
output, by the computing system, the structured output in a machine readable format according to the output structure and the field constraints.

9. The system of claim 8, wherein the document schema further specifies explicit data types and default values for each field, and wherein the instructions further cause the system to assign the respective default values to absent fields in the structured output.

10. The system of claim 8, wherein the document schema supports nested structures and tabular data, and wherein the instructions further cause the system to extract and hierarchically organize nested or tabular information from the input document.

11. The system of claim 8, wherein the instructions further cause the system to, prior to outputting the structured output, evaluate the structured output against ground truth data, and update the document schema in the document schema database based on the evaluation if an accuracy metric falls below a predefined threshold.

12. The system of claim 8, wherein the LMM is prompted with a prompt template that is dynamically generated or adapted based on the selected document schema and the document type identified.

13. The system of claim 8, further comprising:
map, by a graph-based module, relationships among extracted key-value pairs to a graph representation, wherein nodes correspond to keys and edges correspond to relationships between keys;
wherein mapping relationships among extracted key-value pairs to a graph representation comprises identifying a subgraph corresponding to a subset of the extracted keys and relationships, the subgraph being selected to maximize a utility function defined over nodes and edges.

14. The system of claim 8, wherein the document schema includes alias definitions for at least one field, and wherein the instructions further cause the system to recognize and extract values corresponding to any of the alias definitions associated with the field.

15. The system of claim 8, wherein the machine-readable format comprises a structured data format selected from the group consisting of: JSON, XML, and YAML.

16. A non-transitory computer-readable medium storing instructions that, when executed by at least one processor, cause a computing system to perform a method comprising:
receiving, by a computing system, an input document comprising at least one of image data or text data;
generating, by a large multimodal model (LMM) of the computing system, a first set of candidate keys present in the input document via a first type of analysis;
selecting, by the computing system, a document schema from a schema database based at least in part on the first set of candidate keys, the document schema comprising a plurality of fields, each field of the plurality of fields specifying at least one of a key, expected data type, or a default status;
generating, by the LMM of the computing system, a structured output comprising key-value pairs from the input document, the LMM being prompted using the selected document schema to enforce output structure and field constraints; and
outputting, by the computing system, the structured output in a machine-readable format according to the output structure and the field constraints.

17. The non-transitory computer-readable medium of claim 16, wherein the document schema further specifies explicit data types and default values for each field, and wherein the method further comprises assigning the respective default values to absent fields in the structured output.

18. The non-transitory computer-readable medium of claim 16, wherein the document schema supports nested structures and tabular data, and wherein the method further comprises extracting and hierarchically organizing nested or tabular information from the input document.

19. The non-transitory computer-readable medium of claim 16, wherein the method further comprises, prior to outputting the structured output, evaluating the structured output against ground truth data, and updating the document schema in the document schema database based on the evaluation if an accuracy metric falls below a predefined threshold.

20. The non-transitory computer-readable medium of claim 16, wherein mapping relationships among extracted key-value pairs to a graph representation comprises identifying a subgraph corresponding to a subset of the extracted keys and relationships, the subgraph being selected to maximize a utility function defined over nodes and edges.
